(19) United States
(12) Patent Application Publication
(10) Pub. No.: US 2015/0161663 A1
(43) Pub. Date: Jun. 11, 2015

(54) Milestone Driven Data Feed Systems and Methods for Live Events

(71) Applicants: Jason Klein, San Diego, CA (US); Casey L. White, San Diego, CA (US); Christopher F. Williams, Penn Hills, PA (US); Harrison A. Williams, Landenberg, PA (US)

(72) Inventors: Jason Klein, San Diego, CA (US); Casey L. White, San Diego, CA (US); Christopher F. Williams, Penn Hills, PA (US); Harrison A. Williams, Landenberg, PA (US)

(21) Appl. No.: 14/101,944

(22) Filed: Dec. 10, 2013

(51) Int. Cl. G06Q 30/02; G06T 1/00; G06Q 50/00; G06T 11/60

(52) U.S. Cl. CPC G06Q 30/0252; G06T 11/60; G06T 1/0021; G06Q 50/01; G06T 2201/005

(57) ABSTRACT

Exemplary embodiments of the present disclosure relate to a live event (data feed) interaction environment including one or more systems that are programmed and/or configured to facilitate the formation of, distribution of, rendering of, and/or interaction with a data feed for a scheduled live event that includes a schedule of one or more intra-event activities, coupons, and/or any other suitable information, including, for example, social media network feeds. The environment can include a back end feed generation system can be implemented that allows an organizer to specify a schedule of live events and to construct data feeds for the scheduled live events that can be transmitted to user of the environment before, during, and/or after the live event. The environment can include a front end data feed interaction system can be implemented that allows user to view and interact with the data feeds transmitted by the back end system to, for example, participate in the intra-event activities, accumulate and/or redeem coupons, and/or communicate with other users and/or the organizer via one or more social media networks.

### BACKGROUND

Minor League baseball currently has a slightly different type of fan then Major League Baseball and other sporting events or more generally other live events. Fans for Minor League Baseball games may be less about the baseball and more about the “Fun at the Park”. Typically, there are many intra game activities that occur at the ballpark, which can be geared towards children, families, couples, and the like, to enhance the experience of the fans at the ballpark. For example, during a minor league baseball game, a team may organize face painting, running the bases, fireworks, mascot races, trivia competitions, and the like to attract fans to the games. These activities are typically scheduled throughout the game.

While the fan bases may differ between Minor League baseball and other professional sports games or more generally live events, organizers of live events may find it beneficial to schedule intra-event activities for its customers, attendees, fans, etc., to enhance the experience at the live event, increase interaction with customers, attendees, and/or fans, drive traffic to particular areas of a venue at which the live event is occurring to improve sales, sponsor visibility, and the like. It can be difficult for organizers to accomplish these goal using conventional approaches, such as flyers and/or announcements during the live event.

Therefore, it remains a desirable objective to improve communications between organizers of live events and attendees of the live events to improve the attendees' experience at the live event, improve sales for goods and services at the live event, and/or improve visibility of sponsors and/or advertisers associated with the live event.

### SUMMARY

Exemplary embodiments of the present disclosure relate to a live event (data feed) interaction environment including one or more systems that are programmed and/or configured to facilitate the formation of, distribution of, rendering of, and/or interaction with a data feed for a scheduled live event that includes a schedule of one or more intra-event activities, coupons, and/or any other suitable information, including, for example, social media network feeds. The can allow an organizer to specify a schedule of live events and to construct data feeds for the scheduled live events that can be transmitted to user of the environment before, during, and/or after the live event and/or can allow a user to view and interact with the data feeds, for example, participate in the intra-event activities, accumulate and/or redeem coupons, and/or communicate with other users and/or the organizer via one or more social media networks.

In accordance with embodiments of the present disclosure, a computer-implemented method of forming a data feed associated with a live event for transmission to attendees of the live event is disclosed. The method includes executing code to construct a data feed including an intra-event activity for a live event, scheduling the intra-event activity in the data feed according to a milestone associated with the live event via a user interface, associating one or more activity parameters with the intra-event activity, and electronically transmitting the data feed to a computing device associated with an attendee of the live event for rendering of the data feed on a display of the computing device.

In accordance with embodiments of the present disclosure, a system for forming a data feed associated with a live event for transmission to attendees of the live event is disclosed. The system includes one or more non-transitory computer-readable media and one or more processing devices. The one or more non-transitory computer-readable media store executable instructions for forming a data feed for a live event. The one or more processing devices programmed to execute the instructions to construct a data feed including an intra-event activity for a live event, schedule the intra-event activity in the data feed according to a milestone associated with the live event via a user interface, associate one or more activity parameters with the intra-event activity, and initiate transmission of the data feed to a computing device associated with an attendee of the live event for rendering of the data feed on a display of the computing device.

In accordance with embodiments of the present disclosure, one or more non-transitory computer-readable storage media storing executable instructions is disclosure. Execution of the instructions by one or more processing devices causes the one or more processing devices to implement a process of forming a data feed associated with a live event for transmission to attendees of the live event including constructing a data feed including an intra-event activity for a live event, scheduling the intra-event activity in the data feed according to a milestone associated with the live event via a user interface, associating one or more activity parameters with the intra-event activity, and electronically transmitting the data feed to a computing device associated with an attendee of the live event for rendering of the data feed on a display of the computing device.

In accordance with embodiments of the present disclosure, a method of interacting with an attendee of a live event based on data feed associated with the live is disclosed. The method includes receiving a data feed via a computing device, the data feed including an intra-event activity for a live event, the intra-event activity in the data feed being scheduled during the live event according to a milestone of the live event and rendering the intra-event activity in the data feed on a display of the computing device in response to milestone.

In some embodiments, at least a portion of the data feed is electronically transmitted to a computing device based on the milestone.

In some embodiments, a selection of the intra-event activity is received from an activity bank that retrieved from a non-transitory computer-readable storage medium and the intra-event activity is inserted into the data feed in response to the selection.

In some embodiments, one or more activity parameters can be associated with the intra-event activity by receiving an input from an organizer specifying sponsor information for the intra-event activity via the user interface and storing the sponsor information from the organizer for a sponsor parameter of the intra-event activity. The sponsor information can be included in the data feed and can be transmitted in the data feed to the computing device associated with an attendee for rendering of the sponsor information on the display of the computing device with the intra-event activity.

In some embodiments, an intra-event activity is associated with a location on a geographic map of a venue for the live event and a visual indicator is overlaid on the geographic map of the venue to identify the location of the intra-event activity.

In some embodiments, a selection of a coupon is received from a coupon bank that is retrieved from a non-transitory computer-readable storage medium and the coupon is inserted into the data feed in response to the selection.

In some embodiments, a coupon criteria to be satisfied can be implemented before a coupon becomes active and the coupon can be activated in response to satisfaction of the coupon criteria. Satisfaction of the coupon criteria can be achieved upon participation by an attendee in an intra-event activity and/or performance of an action by the attendee in the data feed.

In some embodiments, a social media feed can be incorporated into the data feed.

In some embodiments, the live event can be a baseball game and the milestone is based on innings of the baseball game.

In some embodiments, an image can be captured by an image acquisition device operatively coupled to a computing device of an attendee at the live event and a watermark including sponsor information can automatically be overlaid on the image. An interface with a prepopulated hash tag can be provided to allow the attendee to post the image on a social media network with the hash tag and the image with the watermark can be incorporated into the data feed.

In some embodiments, the data feed can be updated in response to achievement of a milestone. In some embodiments, the achievement of a milestone is determined based on event information.

Any combination and permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

FIG. 1 is a block diagram of a live event data feed environment in accordance with exemplary embodiments.

FIG. 2 is an exemplary client-server environment that can be configured to implement the live event data feed environment in accordance with exemplary embodiments.

FIGS. 3-9 depict exemplary graphical user interfaces that can be rendered on a display of an organizer device to facilitate interaction with a back end system in accordance with exemplary embodiments of the present disclosure.

FIGS. 10-37 depict exemplary graphical user interfaces that can be rendered on a display of a user device to facilitate interaction with a front end system in accordance with exemplary embodiments of the present disclosure.

FIG. 38 is a flowchart of an exemplary process for forming an exemplary data feed to be transmitted from a back end system to a front end system within a live event data feed environment in accordance with exemplary embodiments of the present disclosure.

FIG. 39 is a flowchart of an exemplary process for facilitating an interaction with a data feed transmitted in a live event data feed environment in accordance with exemplary embodiments of the present disclosure.

FIG. 40 is a flowchart of an exemplary milestone creation process that can be implemented in accordance with exemplary embodiments.

FIG. 41 is a block diagram of an exemplary computing device for implementing embodiments of the present disclosure.

### DESCRIPTION OF EXEMPLARY EMBODIMENTS

Exemplary embodiments of the present disclosure relate to a live event (data feed) interaction environment including one or more systems that are programmed and/or configured to facilitate the formation of, distribution of, rendering of, and/or interaction with a data feed for a scheduled live event that includes a schedule of one or more intra-event activities, coupons, and/or any other suitable information, including, for example, social media network feeds. In exemplary embodiments, a back end feed generation system can be implemented that allows an organizer to specify a schedule of live events and to construct data feeds for the scheduled live events that can be transmitted to user of the environment before, during, and/or after the live event. In exemplary embodiments, a front end data feed interaction system can be implemented that allows user to view and interact with the data feeds transmitted by the back end system to, for example, participate in the intra-event activities, accumulate and/or redeem coupons, and/or communicate with other users and/or the organizer via one or more social media networks.

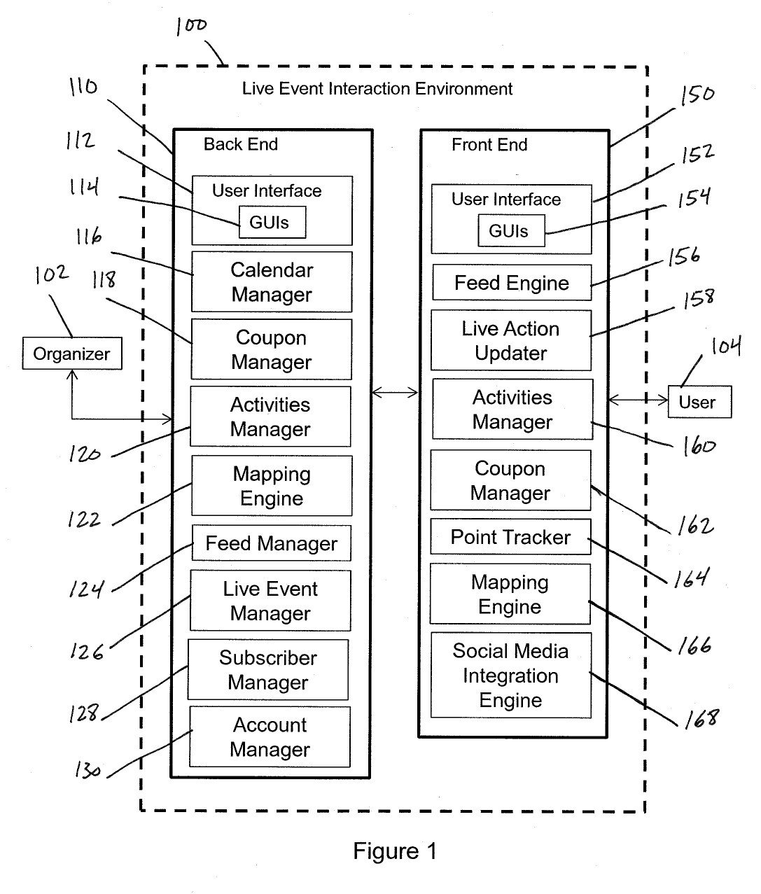

FIG. 1 is a block diagram of an exemplary embodiment of live event (data feed) interaction environment 100. Exemplary embodiments of the environment 100 can be implemented using hardware, software, and/or a combination thereof. For example, in one exemplary embodiment, one or more computing devices can be programmed and/or configured to implement exemplary embodiments of the environment 100. The environment 100 can facilitate formation, transmission, and rendering on displays one or more data feeds including intra-event activities, coupons, social media feeds, and the like associated with a live event. In exemplary embodiments, the environment includes a back end data feed generation system 110 and a front end data feed interaction system 150. The back end system 110 and the front end system 150 can communicate with each other to implement exemplary embodiments of the environment 100.

The back end system 110 can be accessible by an organizer 102 to allow the organizer to a schedule of live events and/or one or more data feeds for the scheduled live events. In exemplary embodiments, the back end system 110 can include a user interface 112, a calendar manager 116, a coupon manager 1118, an activities manager 120, a mapping engine 122, a feed manager 124, a live event manager 126, a subscriber manager 128, and an account manager 130.

The user interface 112 can be programmed and/or configured to provide one or more graphical user interfaces (GUIs) 114 through which the organizer 102 can interact with the system 110. The GUIs 114 displayed to organizer 102 can include data entry areas to receive information from the organizer 102; selectable elements or areas that can be selected by the organizer 102 to cause the system 110 to perform one or more operations, functions, and/or processes; and/or can include data outputs to display information to the organizer 102. In exemplary embodiments, the user interface 112 can be utilized by the operator 102 to interface with one or more components of the system 110.

The calendar manager 116 can be programmed and/or configured to allow an organizer to enter a schedule of live events and/or to reschedule previously scheduled live events (e.g., due to rain). The calendar manager 116 can receive inputs from the organizer 102 (e.g., via one or more GUIs 114 of the user interface 112) to specify parameters for each of the live events entered by the organizer 102 including, for example, dates and times the live events will occur, highlights of activities that will occur at the live events, a type of customer to which the live event and/or the highlighted activities are targeted, whether admission to the live event is free or requires the purchase of a ticket, a mechanism for purchasing a ticket (if required), a featured sponsor of the live event, and/or any other suitable parameters for scheduling and/or defining the live event. For example, for embodiments in which the live event is a sporting event or contest, the organizer 102 can specify the participants in the sporting event or contest.

In some embodiments, the calendar manager 116 can maintain defined sets of options from which the organizer 102 can choose to specify one or more of the parameters. The sets of options can be modified by the organizer 102 to change options, remove options, and/or add options in the sets. After one or more of the parameters have been specified by the organizer 102 for a live event, the calendar manager 116 can store the selected options for the parameters of each scheduled live event and can maintain a chronological ordering of scheduled live events for display to the organizer 102. The organizer 102 can interface with the calendar manager 116 (via the user interface 112) to remove, edit, and/or add live events and selected parameter options associated therewith.

Some examples of live events can include, for example: a sporting event, such as a baseball games, a basketball, games, a football games, tennis matches/tournaments, a hockey games, a wrestling matches/tournaments, boxing matches, and the like; a music concert; a conference (e.g., a business conference or association conference); parties; and/or any other suitable live event for which a group of people attend and for which one or more intra-event activities can be scheduled.

Intra-event activities can be, for example, physical activities and/or virtual activities in which users can participate at a live event. For example, intra-event activities can include contests, trivia, scavenger hunts, three-legged races, raffles, and/or any other activities that can be held at a live event. In some embodiments, the live event is a primary event and the intra-event activities are secondary events that occur to enhance the user's experience at the live event.

The coupon manager 118 can be programmed and/or configured to allow an organizer 102 to define coupons that can be utilized by the user 104 in response to a utilization of the front end system 150 by the user 104. The coupon manager 118 can receive inputs from the organizer 102 (e.g., via one or more GUIs 114 of the user interface 112) to specify coupon parameters for each of the coupons defined by the organizer 102 including, for example, sponsors of the coupons, a logo of the sponsors, a value/discount associated with the coupons, restrictions/requirements for use of the coupons, an expiration date of the coupons, a unique identifier associated with the coupon (e.g., a barcode), and/or can allow the organizer to specify any other suitable parameters to define the coupons.

In some embodiments, the coupon manager 118 can be programmed and/or configured to allow the organizer 102 to define one or more coupon criteria to be satisfied before the user 104 can use a coupon provided by the system 110. The coupon criteria can specify an action to performed by the user 104 or a group of users before the user can redeem the coupon. For example, the coupon criteria can require that the user 104 “like” the coupon via Facebook, post the coupon to the user's social media feed, that a specified number of users “like” the coupon via Facebook, and/or can require any other suitable actions by the user 104 or a group of users before the coupon can be redeemed by the user 104.

The coupon manager 118 can maintain a coupon bank within which the defined coupons can be maintained. The coupon bank can be used to facilitate use and reuse of the coupons by the organizer 102 in one or more data streams output by the system 150 throughout a live event and/or across multiple live events. The coupon bank can be accessible, for example, via the feed manager 122 of the system 110 to allow the organizer 102 to insert coupons into the one more data streams output by the system 110 to control when and/or how the coupons are presented to the user 104 as described herein.

In some embodiments, the coupon manager 118 can maintain defined sets of options from which the organizer 102 can choose to specify one or more of the coupon parameters. The sets of options can be modified by the organizer 102 to change options, remove options, and/or add options in the sets. After one or more of the coupon parameters have been specified by the organizer 102 for a live event, the coupon manager 118 can store the coupons and the selected options for coupon parameters in the coupon bank for subsequent use by the organizer 102. The organizer 102 can interface with the coupon manager 118 (via the user interface 112) to remove, edit, and/or add coupons in the coupon bank and selected coupon parameter options associated therewith.

The activities manager 120 can be programmed and/or configured to allow an organizer 102 to define intra-event activities that can be made available to the user 104 during a live event and can be accessed and/or identified to the user 104 in response to a utilization of the front end system 150 by the user 104. The activities manager 120 can receive inputs from the organizer 102 (e.g., via one or more GUIs 114 of the user interface 112) to specify activity parameters for each of the intra-event activities defined by the organizer 102 including, for example, a title or name of the intra-event activity, sponsors of the intra-event activities, a description of the intra-event activities, types of the intra-event activities, voting options for the intra-event activities (if specified or required), one or more coupons to link to the intra-event activities from the coupon bank, and/or can allow the organizer 102 to specify any other suitable intra-event activity parameters to define the inter activity events.

The activities manager 120 can maintain an activities bank within which the defined intra-event activities can be maintained. The activities bank can be used to facilitate use and reuse of the intra-event activities by the organizer 102 in one or more data streams output by the system 150 throughout a live event and/or across multiple live events. The activities bank can interface with the feed manager 122 of the system 150 to allow the organizer 102 to insert intra-event activities into the one more data streams output by the system 110 to control when and/or how the intra-event activities are presented to the user 104 as described herein.

In some embodiments, the activity manager 120 can maintain defined sets of options from which the organizer 102 can choose to specify one or more of the activity parameters. The sets of options can be modified by the organizer 102 to change options, remove options, and/or add options in the sets. After one or more of the activity parameters have been specified by the organizer 102 for a live event, the activity manager 120 can store the intra-event activity and the selected options for intra-event activity parameters in the activities bank for subsequent use by the organizer 102. The organizer 102 can interface with the activity manager 120 (via the user interface 112) to remove, edit, and/or add intra-event activities in the activities bank and selected activity parameter options associated therewith.

The mapping engine 122 can be programmed and/or configured to allow the organizer to populate a map of a venue at which a live event is scheduled to occur with visual indicators that identify the locations of intra-event activities. For example, the mapping engine 122 can interact with the activities manager 120 such that when the organizer specifies a location of the intra-event activity, the mapping engine 122 can incorporate a visual indicator on the map corresponding to the event. The visual indicators included in the map can be linked to the intra-event activities so that the visual indicators can be selectable to display information about the locations identified by the visual indicators and/or information about the intra-event activities schedule to occur at the locations. In some embodiments, the visual indicators can be configured to appear/disappear based on milestones that occurring during the live event such the user 104 can see where intra-event activities are taking place during the event. In some embodiments, the mapping engine 122 can allow the organizer 102 to specify other locations that may be of interest to the user including vendor locations, bath room locations, exit locations, and the like.

The feed manager 124 can be programmed and/or configured to allow the organizer to define a feed schedule for a scheduled live event. The feed schedule can include schedule slots for intra-event activities, coupon offers, social media feeds, map location information, and/or any other information that may be useful and/or of interest to a user. For example, the feed manager 124 can be programmed and/or configured to interact with the calendar manager to allow the organizer 102 to select a scheduled live event for which the organizer 102 wishes to define an interactive data feed and can be programmed and/or configured to interact with the coupon manager 118, the activities manager 120, the mapping engine 122 to allow the organizer to select and insert coupons, intra-event activities, and/or map location information, respectively, into the data feed as feed entries for a selected live event. In exemplary embodiments, the feed manager 124 can be programmed to allow the organizer to select and insert social media feeds into the data as feed entries.

In exemplary embodiments, the feed manager 124 can include schedule slots within which the intra-event activities, coupons, social media feeds, and/or map location information can be inserted or to which they can be mapped as feed entries. The schedule slots can be defined based on checkpoints/milestones associated with the selected live event. The milestones can be time-dependent and/or can be time-independent. As one example, in some embodiments, when the selected live event corresponds to a baseball game, the feed manager 124 can be programmed and/or configured to define schedule slots based on half inning increments such that intra-event activities and/or coupons can be inserted into the data feed according to the half inning increments. As another example, in some embodiments, the feed manager 124 can be programmed and/or configured to define schedule slots based on an amount of time that has elapsed from a start time. When the schedule slots are time dependent, the schedule slots can correspond to time increments, such as fifteen minute time increments such that intra-event activities and/or coupons can be inserted into the data feed according to the fifteen minute time increments.

The milestones can be created via a milestone creation process implemented, for example, by the feed manager 124. The milestone creation process can allow the organizer 102 to specify a milestone type (e.g., Baseball) and to create any number of milestones to be associated with the specified milestone type. In exemplary embodiments, each milestone can be given a name (e.g., based on what the milestone represents). The milestones created having a specified milestone type can be associated with or assigned to an event type (e.g., Baseball game). Scheduled live events can be associated with an event type to associate the milestones in the milestone type with the schedule live events to define the milestones for the data feed of the scheduled live events.

In some embodiments, the milestones utilized to define the schedule slots can be homogeneous. That is, each of the milestones in the data feed can be defined based on the same type of milestone (e.g., half innings or fifteen minute increments). In some embodiments, the milestones utilized to define the schedule slots can be heterogeneous. That is, one or more of the milestones in the data feed can be defined using a different type of milestone than other milestones in the data feed (e.g., some milestones can be defined based on half innings and other milestones can be defined based on fifteen minute increments).

Different live events can utilize different milestones to define the schedule slots in a data feed. As one example, if the live event is a football game, the milestones can be changes of possession, first downs, touchdowns, field goals, time out, starts of quarters, ends of quarters, a set time increment (e.g., every fifteen minutes), and the like. In some embodiments, the milestones can be defined to enhance the user experience at the live event without detracting from the live event itself such that the milestones can correspond to points during the live event, where there is a natural break in the event's action. In some embodiments, the milestones can be defined to at anytime during the live event such that the milestones can defined independent of natural breaks in the event's action.

When a scheduled live event occurs (including an pre or post event activities), the feed manager 124 can transmit the data feed associated with the scheduled event to the system 150. In some embodiments, the feed manager 124 can transmit the entire data feed to the system 150 before or at the beginning of the event, during the live event, and/or after the live event. In some embodiments, the feed manager 124 can transmit the data feed to the system 150 according to the milestones defined by the feed manager 124 so that the data feed is transmitted to the system 150 in increments. In some embodiments, the feed manager 124 can transmit the data feed or portions thereof to the system 150 in response a request received from the system 150. In some embodiments, the data feed transmitted to the system 150 can be a static feed such that once the data feed is transmitted to the system 150 from the system 110, the data feed does not change and the user of the system 150 can access the entries in the data feed. In some embodiments, the organizer 102 can update and/or modify a data feed that has previously been transmitted from the system 110 to the system 150 and the systems 110 and 150 can be programmed and/or configured to automatically sync to allow the data feed to be updated in the system 150.

In addition to the intra-event activities and/or coupons, the feed manager 124 can be configured to include social media feeds such as Facebook, Twitter, Instagram, and/or any other social media feeds. The organizer 102 can specify a social media hash tag that can be used to identify the live event and/or a participant in the live event (e.g., a baseball team). Using this approach, in some embodiments, the feed manager 124 can distribute the social media feeds in the feed throughout the live event to facilitate interaction between the organizer 102 and the user 104 as well as between the user 104 and other users in the environment 100 and/or between the user 104 and contacts, “friends”, or “followers” of the user's social media account.

In some embodiments, the data feeds generated using the feed manager 124 can be stored and/or reused in their entirety, or in part, for other scheduled live events such that once a data feed is created, the data feed can be available as a template for subsequent scheduled live events. The data feeds can be stored in a feed bank, which can be accessible by the organizer when generating a data feed for a scheduled live event.

The live event manager 126 can be programmed and/or configured to allow the organizer 102 to dynamically control and/or modify the data feed generated by the feed manager 124 before, during, and/or after the live event. The live event manager 126 (via the user interface 112) can render the control interface on a display through which the organizer 102 can control and/or modify the data feed. The control interface can provide the organizer with access to information maintained by the system 150 that corresponds to users that have subscribed to the environment 100 and/or that are participating in the activities and/or coupons provided by the data feed generated by the feed manager 124, can allow the organizer to select contest/activities winners, and can allow the organizer 102 to send instant coupons to users and/or otherwise interact with the users.

In some embodiments, the control interface provided by the live event manager can allow the organizer to manually update live event parameters. For example, if the live event is a baseball game, the control interface can allow the organizer to update a score of the baseball game and/or an inning of the baseball game. In some embodiments, the live event parameters can be updated automatically without any intervention of the organizer 102. For example, in some embodiments, at least some of the live event parameters can be programmatically received from a source external to the systems 110 and 150 (e.g., an external live feed of game updates for a baseball game including score and inning information). The live event manager 126 can automatically update the live event parameters in the data feed and transmit the updates to the system 110. In some embodiments, the external feed can be received by the system 150 from the external source and the live event parameters in the data feed can be programmatically updated by the system 150. The updates received from the external live feed can be used by the system 110 and/or the system 150 to determine when one or more milestones have been reached such that the system 110 and/or the system 150 can automatically update the data feed based on the milestones achieved as determined via external live feed.

The subscriber manager 128 can be programmed and/or configured to maintain information about the users of the environment 100 (e.g., the user 104). The user information can include a name of the user, an e-mail address of the user, a phone number of the user, a username/nickname of the users, a number points awarded to the users, activities in which the user participates via the system 150, coupons redeemed by the users, and/or any other suitable information to identify and/or analyze user participation via the system 150. In some embodiments, the organizer 102 can interact with the subscriber manager 128 to determine winners of intra-event activities. In some embodiments, the organizer 102 can interact with the subscriber manager 128 to view and/or analyze information about the users to determine an effectiveness of a specified intra-event activity and/or coupon (e.g., based on participation and/or usage statistics), a value of the environment to sponsors and/or advertisers, and the like.

The subscriber manager 128 can be programmed and/or configured to automatically select users that have signed up for one or more activities randomly or based on a sign-up criteria. For example, in some embodiments, users may sign up to participate in an intra-event activity having a limited number of openings for participants such that not all of the user that signed up for the activity will be able to participate in the activity. For these embodiments, the subscriber manager 128 can fill the openings for the activity using the sign-up information using a lottery system and/or based on sign-up criteria, which may include, for example, an age requirement.

The account manager 130 can be programmed and/or configured to determine who can access the system 110. For example, the account manager can manage usernames and passwords of organizers that can access the system 110 and can be controlled to assign different levels of access to different individuals and/or groups of individuals such that tasks, operations, and/or function performed by certain individuals and/or groups of individuals can be restricted.

The front end system 150 can be accessible by a user 104 to allow the user to view and interact with a data feed that is transmitted to the front end system by the back end system 110. In exemplary embodiments, the front end system 150 can include a user interface 152, a feed engine 156, a live action updater 158, an activities manager 160, a coupon manager 162, a point tracker 164, a mapping engine 166, and a social media integration engine 168.

The user interface 152 can be programmed and/or configured to provide one or more graphical user interfaces (GUIs) 154 through which the user 104 can interact with the system 150. The GUIs 154 displayed to user 104 can include data entry areas to receive information from the user 104; selectable elements or areas that can be selected by the user 104 to cause the system 150 to perform one or more operations, functions, and/or processes; and/or can include data outputs to display information to the user 104. In exemplary embodiments, the user interface 152 can be utilized by the user 104 to interface with one or more components of the system 150.

The feed engine 156 can be programmed and/or configured to receive the interactive data feed generated by the system 110 and to interact with the user interface 152 to render the data feed or portions thereof on a display of the user's device. For example, the data feed can be received by the feed engine 156 as a data stream that includes milestone information, live event activities, coupons, social media feeds associated with the organizer 104, live event information, and/or any other suitable information that can be utilized by exemplary embodiments of the system 150. In exemplary embodiments, the user 104 can select one or more live event activities, coupons, social media feeds, and/or live event information to perform one or more actions within the system 150.

The live event updater 158 can be programmed and/or configured to update the data feed information rendered and the display of the user's device automatically in response to a satisfaction of a milestone in the data feed, in response to a request from the user 104, and/or automatically upon receipt of an updated data feed received from the system 150. The live event updater can create a dynamic feed experience for the user 104 such that the information rendered on the display can change periodically or otherwise to give the user 104 a sense progression during the live event.

The activities manager 160 can be programmed and/or configured to maintain and/or track which intra-event activities the user 104 participated in or will participate in. For example, when the user 104 selects an intra-event activity from the data feed, the user may input further selections to join in the intra-event activity and/or sign up for an intra-event activity. The activities manager can store the user's selection and can provide a record of the selections that can be reviewed by the user 104. In some embodiments, the activities manager can be programmed and/or configured to alert the user when it is time to participate in an intra-event activity that the user has selected for participation. The activities manager 160 can transmit the user's activities information to the system 150 when the user signs up to participate in an intra-event activity, indicates that the user will participate in an intra-event activity, participates in an intra-event activity, and the like so that the user's activities information can be utilized by the system 150 as described herein.

In some embodiments, the data feed can include entries correspond to activities and/or other items that are scheduled to occur outside of (i.e. after or before) a live event. The user 104 can sign-up for these activities and/or other items in the data feed and the activities manager 160 can maintain and/or track which activities and/or other items for which the user 104 has signed up via the system 150.

The coupon manager 162 can be programmed and/or configured to maintain and/or track which coupons the user 104 has accumulated and/or redeemed. For example, when the user 104 accumulates a coupon from the data feed, the user 104 store the coupon and/or may choose to redeem the coupon. The coupon manager 162 can store the coupons for the user 104 and can provide a record of the coupons accumulated and/or redeemed by the user 104. In some embodiments, the coupon manager 162 can be programmed and/or configured to alert the user when a coupon accumulated by the user 104 becomes valid or invalid. The coupon manager 162 can transmit the user's coupon information to the system 150 when the user accumulates and/or redeems of coupon so that the user's coupon information can be utilized by the system 150 as described herein.

The point tracker 166 can be programmed and/or configured to maintain a quantity of points that the user 104 has accumulated via the system 150. For example, points can be awarded to the user 104 for interacting with the system 150 by participating in intra-event activities, accumulating and/or redeeming coupons, submitting social media posts having a specified hash tag, interacting with a social media post having a specified hash tag, and/or for any other suitable interactions with the system 150.

The mapping engine 168 can be programmed and/or configured to render a map on a display of the user's device that includes visual indicators that identify the locations of intra-event activities at the venue where the live event is occurring. The user 104 can interact with the map to select the visual indicators to render information about the locations and/or intra-event activities scheduled to occur at the location during the live event. The mapping engine 168 can allow the user 104 to pan to view different areas of the venue and, in some embodiments, can dynamically update the visual indicators on the map based on when the intra-event activities are scheduled.

The social media integration engine 168 can be programmed and/or configured to integrate the user's social media feeds into the data feed provided by the system 150. For example, the social media integration engine 170 can request the user social media user names and passwords to log the user 104 into the user's social media accounts through the system 150 such that posts made by the user 104 can be incorporated into the user's social media feeds and the user's contacts, “friends”, and/or “followers” social media feeds.

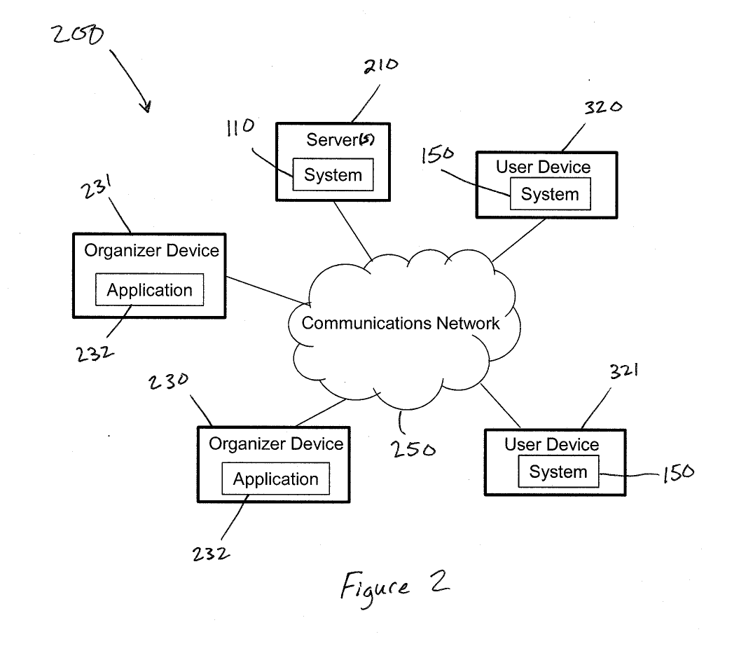

FIG. 2 is an exemplary client-server environment 200 that can be configured to implement exemplary embodiments of the environment 100. The environment 200 includes server(s) 210 operatively coupled to users devices 220-221 and organizer devices 230-231, via a communication network 250, which can be any network over which information can be transmitted between devices communicatively coupled to the network. For example, the communication network 250 can be the Internet, Intranet, virtual private network (VPN), wide area network (WAN), local area network (LAN), and the like. The server(s) 210, user devices 220-221, and organizer devices 230-231 can be implemented as computing devices executing an embodiment of the system 110, an embodiment of the system 150, and a client side application 232, respectively. In exemplary embodiments, the client side application implemented by the organizer devices 230-231 can be a web browser application and/or can be a specific application implemented to interact with the system 110. In some embodiments, the system 110 can be implemented by a single server or the system 110 can be distributed across multiple severs such that each server is programmed and/or configured to perform a portion of the system 110. In an exemplary embodiment, the server 210 can be web server and/or include web server functionality configured to host web pages. The organizer 102 can access the system 110 hosted by the server 210 using the client side application 232 (e.g., a web browser) to view one or more GUIs generated by the system 110.

In an exemplary operation, organizer entities (e.g., baseball teams) can have accounts with the system 110 to allow the organizer entities to access the system 110 via the organizer devices 230-231 and define scheduled live events for their organization. For example, an organizer interact with the organizer device 230 to execute the client side application 232 to communicate with the server 210 to access the organizations account on the system 110 to view a personalized (branded) user interface. Through this communication, the organizer can enter one or more scheduled live events into the system 110 (e.g., executing the calendar manager 116). The organizer can access one or more GUIs (e.g., GUIs 114) of the system 110 to define coupons to be stored in the coupon bank (e.g., upon execution of the coupon manager 118 by the server 210), to define intra-event activities to be stored in an activities bank (e.g., upon execution of the activities manager 120 by the server 210), and to define a feed that includes coupons and intra-event activities according to one or more milestones (e.g., upon execution of the feed manager 124 by the server 210).

A user can interact with the user device 220 to execute the system 150. Upon execution of the system 150, the user can view scheduled live events and can access information about the scheduled live events, including, for example, a description of the live events and a mechanism for purchasing tickets to the live events. Upon the occurrence of a live event included in the schedule of live events by the organizer, the user can interact with the user device 230 to execute the system 150 to receive a data feed, or a portion thereof, from the server 210 executing the system 110, which can be displayed in one or more GUIs (e.g., GUIs 154) on a display of the user device 230. The user can view the data feed rendered on the display of the user device 230 and can interact with the display to participate in intra-event activities referenced in the data feed, to accumulate points based on an interaction with the data feed, and/or to accumulate coupons offered via the data feed. As the live event reaches milestones defined in the data feed, the system 150, independently or in response to instructions received from the system 110, can update the data feed to include intra-event activities and/or coupons corresponding to the milestones.

FIGS. 3-9 depict exemplary GUIs (e.g., GUIs 114) that can be rendered on a display of an organizer device to facilitate interaction with the system 110 by an organizer in accordance with exemplary embodiments of the present disclosure. The GUIs of FIGS. 3-9 depict an exemplary embodiment in accordance with the present disclosure for implementing the environment with respect to baseball games. While FIG. 3-9 are described with respect to baseball games, those skilled in the art will recognize that exemplary embodiments can be implemented for other sporting events (e.g., basketball football, soccer, hockey, tennis, boxing, etc.) and/or other live events (e.g., conferences, parties, movie screenings, etc.)

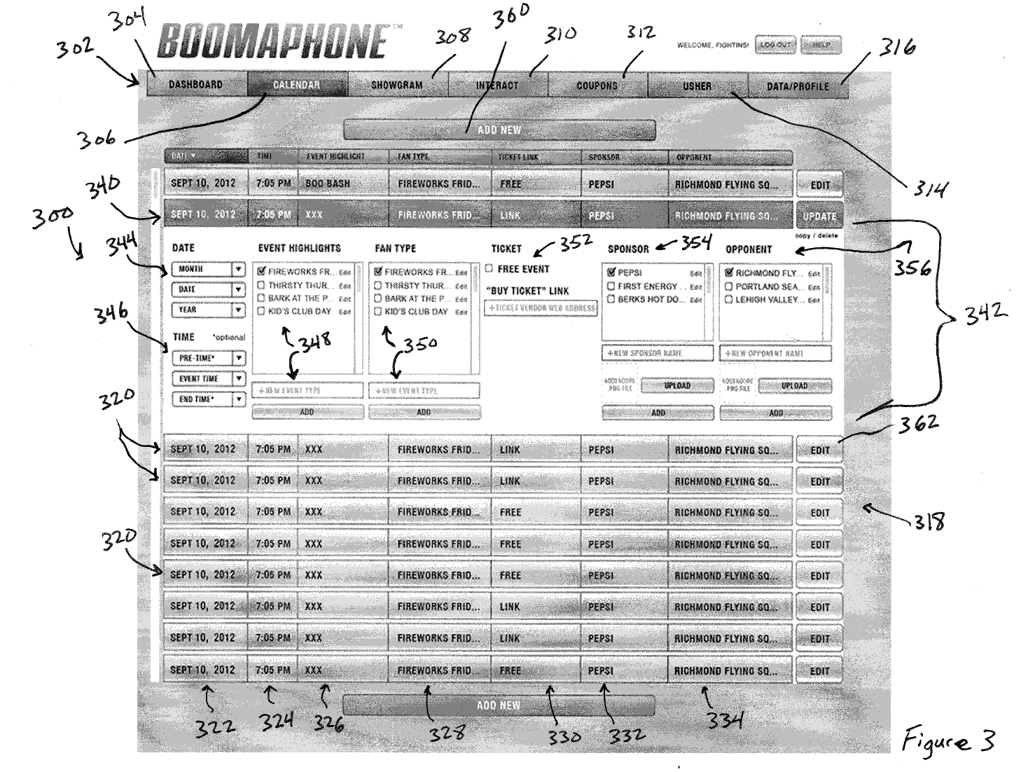

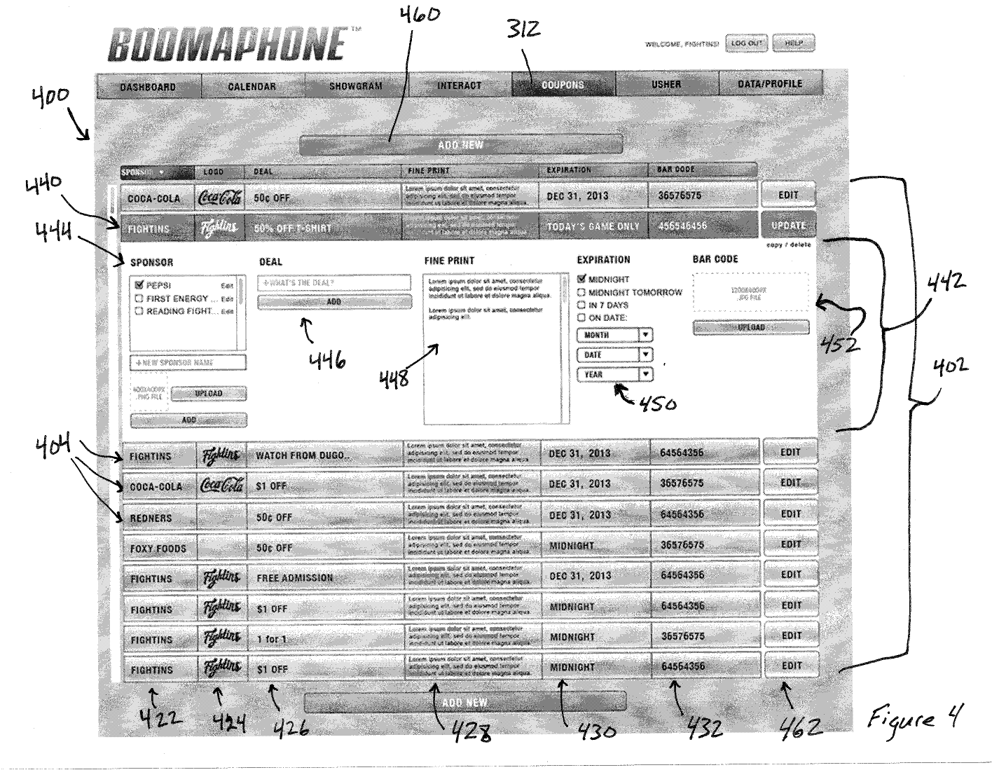

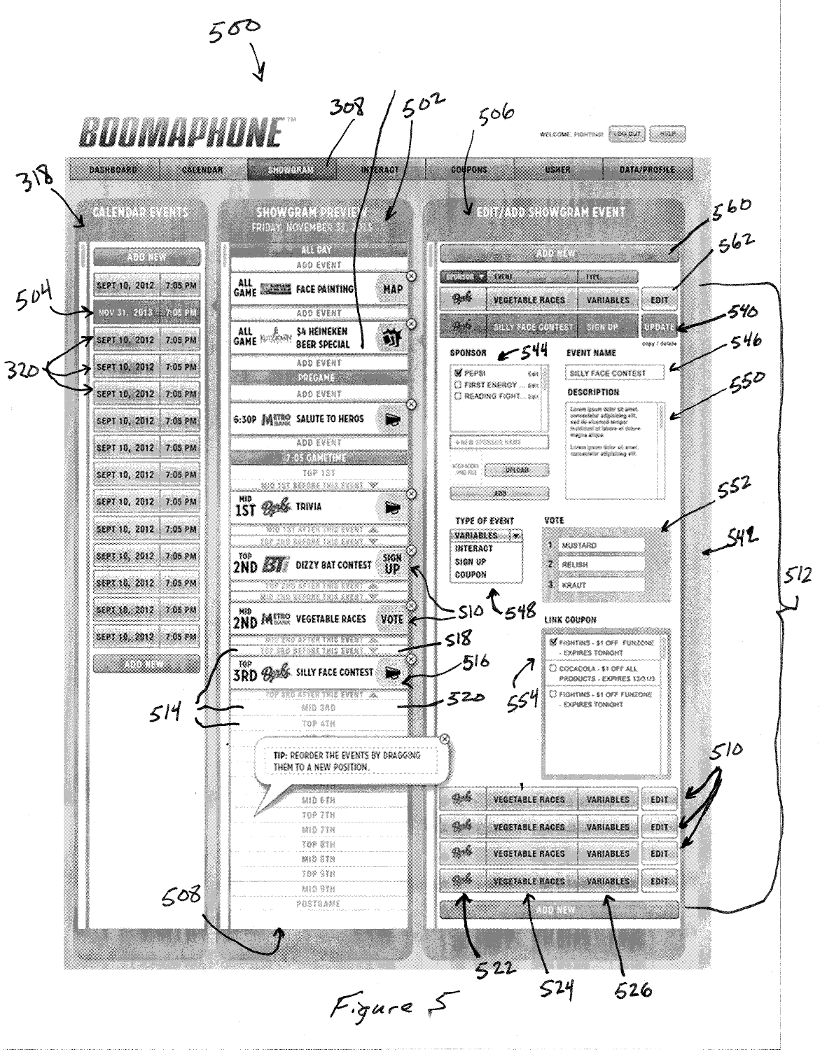

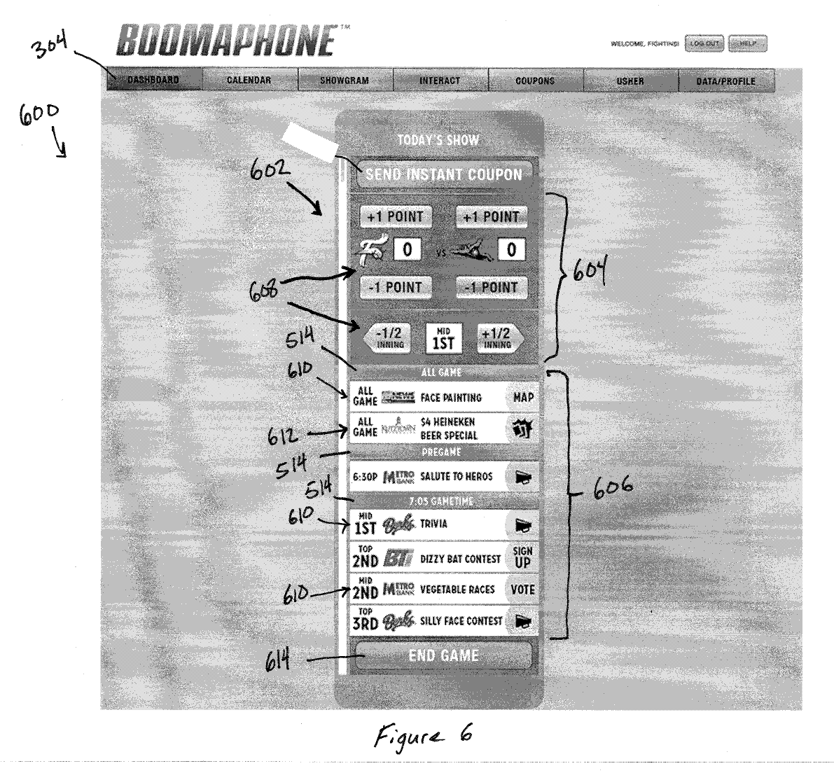

FIG. 3 depicts a GUI 300 that can be rendered on an organizer device to allow an organizer for a baseball team to interact with a calendar manager (e.g., calendar manager 116) of the system 110. The GUI 300 can include view options 302 that can be selectable by the organizer to navigate through the GUIs that can be generated by the system 110. The view options 302 can include a “Dashboard” option 304, a “Calendar” option 306, a “Showgram” option 308, an “Interact” option 310, a “Coupons” option 312, an “Usher” option 314, and a “Data/Profile” option 316. The option 304 can be selected by an organizer to navigate to a GUI 600 (FIG. 6) to control a data feed corresponding to a scheduled baseball game that is occurring. The option 306 can be selected by the organizer to navigate to the GUI 300 to enter scheduled baseball games. The option 308 can be selected by the organizer to navigate to a GUI 500 (FIG. 5) to define data feeds for one or more of the scheduled baseball games. The option 310 can be selected by the organizer to navigate to a GUI to allow the organizer to interact with users in the environment 100 and/or to allow the organizer to specify various social media feeds (e.g., Facebook, Twitter, Instgram) to be incorporated into a data feed for a scheduled live event including any social media parameters to be utilized in the data feed (e.g., hash tags, @, etc.). The option 312 can be selected by the organizer to navigate to a GUI 400 (FIG. 4) to allow the organizer to define one or more coupons that can be stored in a coupon bank. The option 314 can be selected by the organizer to navigate to a GUI that allows the organizer to enter information related to the baseball team and/or the venue at which the baseball team plays. The option 316 can be selected by the organizer to navigate to a GUI to allow the organizer to view and/or analyze information collected and/or maintained by the system 150 include, for example, information about the users that have subscribed to the system 110, sales information, statistics regarding usage of the systems 110 and/or 150, and the like.

As shown in FIG. 3, the GUI 300 includes scheduled baseball games 320 that have been entered by the organizer. The GUI 300 can provide an interface between the organizer and an embodiment of the calendar manager 116, which can be executing in the background to populate the GUI 300 and/or perform one or more actions, functions, or operations in response to inputs received from the organizer. The scheduled baseball games 320 can be displayed as a list 318 having rows and columns that display at least some of the parameters that can be entered by the organizer when entering, updating, modifying, and/or adding scheduled baseball games. The scheduled baseball games can be listed in a chronological order. The parameters defining the columns can include a date parameter 322 to identify a date of the baseball game, a start time 324 of the baseball game, a highlighted intra-event activity 326, a main attraction of the live event 328, a ticket requirement 330, a feature sponsor 332, and an opponent 334.

The organizer can select one of the scheduled baseball games to specify one or more of the parameters for the selected baseball game. For example, the organizer can select a scheduled baseball game 340 to show a parameter entry area 342 for the selected baseball game 340 that includes data entry fields for the date parameter 322, the start time parameter 324, the highlighted intra-event activity parameter 326, the targeted attendee parameter 328, the ticket requirement parameter 330, the feature sponsor parameter 332, and the opponent parameter 334.

To specify the date parameter 322 of the selected baseball game 340, the organizer can enter information in the data entry fields 344, which can be implemented as drop down menus that include a month, date, and year of the scheduled baseball game 340.

To specify the start time parameter 324 of the selected baseball game 340, the organizer can enter information in the data entry fields 346, which can be implemented as drop down menus that include a pre-time, an event time, and an end time of the scheduled baseball game 340. The pre-time can be specified if the organizer wishes to provide intra-event activities and/or coupon offers before the baseball game starts.

To specify the activity parameter 326 of the selected baseball game 340, the organizer can enter information in the data entry fields 348, which, in part, can be implemented as a list of selectable intra-event activities. If an intra-event activity is not included in the list, the organizer can add the intra-event activity to the list using one or more of the data entry fields 348.

To specify the main attraction parameter 328 of the selected baseball game 340, the organizer can enter information in the data entry fields 350, which, in part, can be implemented as a list of selectable intra-event activities. If a main attraction is not included in the list, the organizer can add the intra-event activity to the list using one or more of the data entry fields 350.

To specify the ticket requirement parameter 330 of the selected baseball game 340, the organizer can enter information in the data entry fields 352. If there is no charge for admission, the organizer can select one of the data entry fields 352. If there is an admission charge, the organizer can inter ticket purchasing information (e.g., such as a URL address of a vendor responsible for selling the tickets) in the one of the data entry fields 352.

To specify the featured sponsor parameter 332 of the selected baseball game 340, the organizer can enter information in the data entry fields 354, which, in part, can be implemented as a list of selectable sponsors. If a sponsor is not included in the list, the organizer can add the sponsor and a sponsor logo using one or more of the data entry fields 354.

To specify the opponent parameter 334 of the selected baseball game 340, the organizer can enter information in the data entry fields 356, which, in part, can be implemented as a list of selectable opponents. If an opponent is not included in the list, the organizer can add the opponent and an opponent's logo using one or more of the data entry fields 356.

When the organizer wishes to add a new baseball game to the calendar, the organizer can select an “Add New” button 360, which can add a scheduled baseball game to the list of scheduled baseball games. Subsequently, the organizer can specify the parameters for the newly added baseball game. If the user wishes to edit the parameters of a previously entered scheduled baseball game, the user can select an “Edit” button 362 to expand the view to show the parameter entry area for the scheduled baseball game for which the parameters are to be edited.

FIG. 4 depicts a GUI 400 that can be rendered on a display of an organizer device in response to a selection of the “Coupons” option 312 to allow an organizer for a baseball team to interact with a coupon manager (e.g., coupon manager 118) of the system 110. As shown in FIG. 4, the GUI 400 includes a coupon bank 402 that includes coupons that have been defined by the organizer. The GUI 400 can provide an interface between the organizer and an embodiment of the coupon manager 118, which can be executing in the background to populate the GUI 400 and/or perform one or more actions, functions, or operations in response to inputs received from the organizer. Coupons 404 in the coupon bank 402 can be displayed in rows having columns that display at least some of the coupon parameters that can be entered by the organizer when entering, updating, modifying, and/or adding coupons to the coupon bank 402. The coupon parameters defining the columns can include a sponsor parameter 422 to identify a sponsor of the coupon, a logo parameter 424 of the sponsor, a description or title parameter 426 of the coupon, a fine print parameter 428 associated with the coupon, an expiration date parameter 430 of the coupon, and a barcode parameter 432 for the coupon.

The organizer can select one of the coupons 404 in the coupon bank 402 to specify one or more of the coupon parameters for the selected coupon. For example, the organizer can select a coupon 440 to show a parameter entry area 442 for the selected coupon 440 that includes data entry fields for the sponsor parameter 422, the logo parameter 424, the title parameter 426, the fine print parameter 428, the expiration date parameter 430, and the barcode parameter 432.

To specify the sponsor parameter 422 for the selected coupon 440, the organizer can enter information in data entry fields 444, which, in part, can be implemented as a list of selectable sponsors. If a sponsor is not included in the list, the organizer can add the sponsor to the list using one or more of the data entry fields 444.

To specify the sponsor logo parameter 424 for the selected coupon 440, the organizer can enter information in the data entry fields 444, which can used to upload a logo for the sponsor (if one has not already been uploaded and to associate the logo with a selected sponsor.

To specify the title parameter 426 for the selected coupon 440, the organizer can enter information in the data entry fields 446, which can include a text box to receive the title and an add button to specify the title for the selected coupon 440.

To specify the fine print parameter 428 for the selected coupon 440, the organizer can enter information in the data entry field 448, which can include a text box to receive the fine print for the selected coupon 440.

To specify the expiration date parameter 430 of the selected coupon 440, the organizer can enter information in the data entry fields 450, which can be implemented using check boxes and dropdown menus.

To specify the barcode parameter 432 of the selected coupon 440, the organizer can enter information in the data entry fields 452, which can allow the organizer to upload a barcode associated with the selected coupon 440.

When the organizer wishes to add a new coupon to the coupon bank 402, the organizer can select an “Add New” button 460, which can add a coupon to the list of coupons 404 in the coupon bank 402. Subsequently, the organizer can specify the coupon parameters for the newly added coupon. If the user, wishes to edit the coupon parameters of a previously entered coupon, the organizer can select an “Edit” button 462 to expand the view to show the parameter entry area for the coupon for which the coupon parameters are to be edited.

FIG. 5 depicts a GUI 500 that can be rendered on a display of an organizer device in response to a selection of the “Showgram” option 308 to allow an organizer for a baseball team to interact with a feed manager (e.g., feed manager 124) of the system 110. The GUI 500 can provide an interface between the organizer and an embodiment of the feed manager 124, which can be executing in the background to populate the GUI 500, and/or can perform one or more actions, functions, or operations in response to inputs received from the organizer. As shown in FIG. 5, the GUI 500 includes a feed definition area 502, which can be displayed for a selected scheduled baseball game 504 from the list 318 of scheduled baseball games 320. An intra-event activities area 506 can be displayed to allow the organizer to populate a data feed 508 in the feed definition area 502 with intra-event activities 510 of an activities bank 512.

Milestones 514 can be defined for the data feed 508 to facilitate scheduling of intra-event activities and/or coupon offers. In the present embodiment, the milestones 514 are defined in half inning increments for the selected baseball game 504. The organizer can add one or more of the intra-event activities 510 to the data feed 508 by selected the intra-event activities 510 and dragging the selected intra-event activities into the data feed 508. The intra-event activities 510 can be positioned within the data feed 508 to specify a schedule of intra-event activities for the selected baseball game 504 with respect to the milestones 514. For example, an intra-event activity 516 can be positioned within the data feed after a milestone 518 corresponding to the top of the third inning and before a milestone 520 corresponding to the middle of the third inning such that the event is scheduled to take place at the top of the third inning. In some embodiments, the organizer can add coupon offers using a substantially similar process as adding intra-event activities. The data feed 508 permits the organizer to reorder or reposition the intra-event activities included in the data feed 508 by dragging the intra-event activities to different locations in the data feed 508.

The intra-event activities 510 in the activities bank 512 can be displayed in rows having columns that display at least some of the activity parameters that can be entered by the organizer when entering, updating, modifying, and/or adding intra-event activities to the activities bank 512. The activity parameters defining the columns can include a sponsor parameter 522 to identify a sponsor of the intra-event activities, an activity title parameter 524 of the intra-event activity, and an activity type parameter 526.

The organizer can select one of the intra-event activities in the activities bank 512 to specify one or more of the activity parameters for the selected activity. For example, the organizer can select an intra-event activity 540 to show a parameter entry area 542 for the selected activity 540 that includes data entry fields for the sponsor parameter 522, the activity title parameter 524, and the activity type parameter 426. In exemplary embodiments, the parameter entry area can also include data entry fields for an activity description parameter, a voting parameter, and a linked coupon parameter.

To specify the sponsor parameter 522 for the selected activity 540, the organizer can enter information in data entry fields 544, which, in part, can be implemented as a list of selectable sponsors. If a sponsor is not included in the list, the organizer can add the sponsor to the list using one or more of the data entry fields 544.

To specify the activity title parameter 524 for the selected activity 540, the organizer can enter information in the data entry fields 546, which can include a text box to receive the title and an add button to specify the title for the selected activity 540.

To specify the activity type parameter 526 of the selected activity 540, the organizer can enter information in the data entry fields 548, which can be implemented as a drop down menu that includes different activity types for that can be selected for the selected activity 540.

To specify the description parameter for the selected activity 540, the organizer can enter information in the data entry field 550, which can include a text box to receive the description for the selected activity 540.

To specify the voting parameter of the selected activity 540, the organizer can enter information in the data entry fields 552, which can be implemented using text boxes.

To specify the linked coupon parameter of the selected activity 540, the organizer can enter information in the data entry fields 554, which can be implemented as a list of selectable coupons from the coupon bank. The linked coupon parameter can be used by the organizer to associate one or more coupons with the selected activity 540 such that participation in the intra-event activity by a user may result in accumulation of the coupon by the user depending on any criteria associated with the event or criteria.

When the organizer wishes to add a new intra-event activity to the activities bank 512, the organizer can select an “Add New” button 560, which can add an intra-event activity to the list of intra-event activities in the activities bank 512. Subsequently, the organizer can specify the activity parameters for the newly added intra-event activities. If the user, wishes to edit the activity parameters of a previously entered intra-event activity, the organizer can select an “Edit” button 562 to expand the view to show the parameter entry area for the selected intra-event activity for which the activity parameters are to be edited.

FIGS. 6-9 depict a GUI 600 that can be rendered on a display of an organizer device in response to a selection of the “Dashboard” option 304 to allow an organizer for a baseball team to interact with a live event manager (e.g., live event manager 126) of the system 110. As shown in FIG. 6, the GUI 600 includes a control interface 602. The control interface 602 can provide an interface between the organizer and an embodiment of the live event manager 126, which can be executing in the background to populate the control interface 602 and/or perform one or more actions, functions, or operations in response to inputs received from the organizer. The control interface 602 can provide a feed information for a baseball game that is presently scheduled to be played such that the organizer can view the feed information being provided to the users during the baseball game.

As shown in FIG. 6, the control interface 602 can includes an event parameter control area 604 and an feed control area 606. The event parameter control area 604 can include event controls 608 that allow the organizer to update and/or modify event parameters, such as a score of the baseball game and or an inning of the baseball game. The feed control area 606 can include intra-event activities 610 and coupon 612 offerings included in the data feed for the baseball game and can show the intra-event activities and coupon offerings with respect to the milestones 514. The organizer can select the intra-event activities 610 and coupons 612 to edit, remove, or reorder the intra-event activities 610 and coupons 612 in the data feed to dynamically alter an arrangement of the data feed being viewed by a user. To end the data feed, the organizer can select the “End Game” button 614.

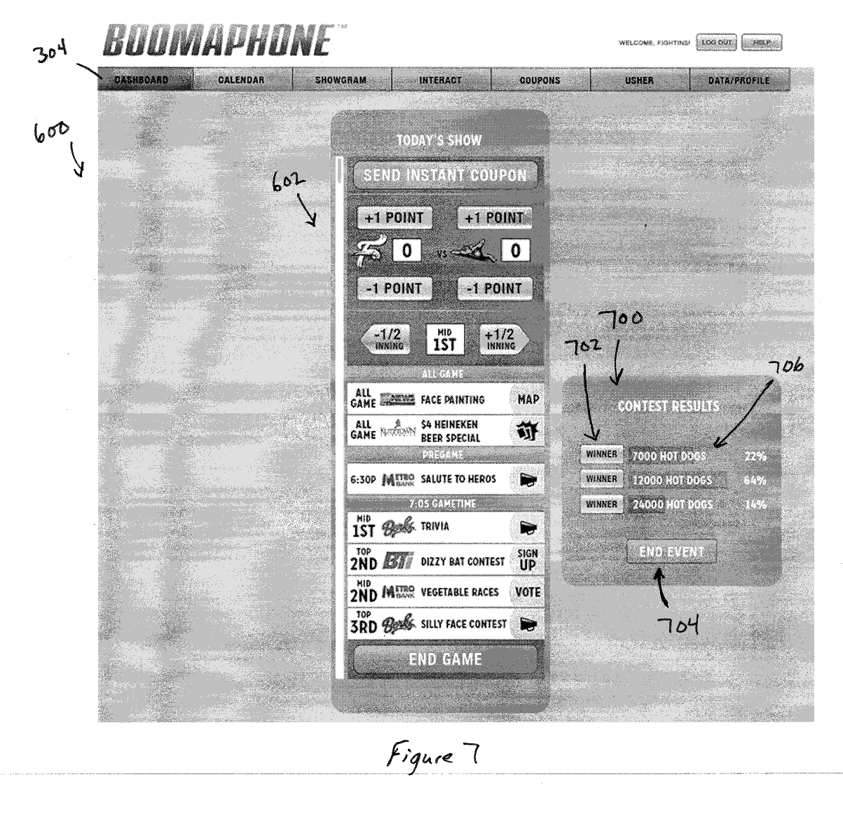

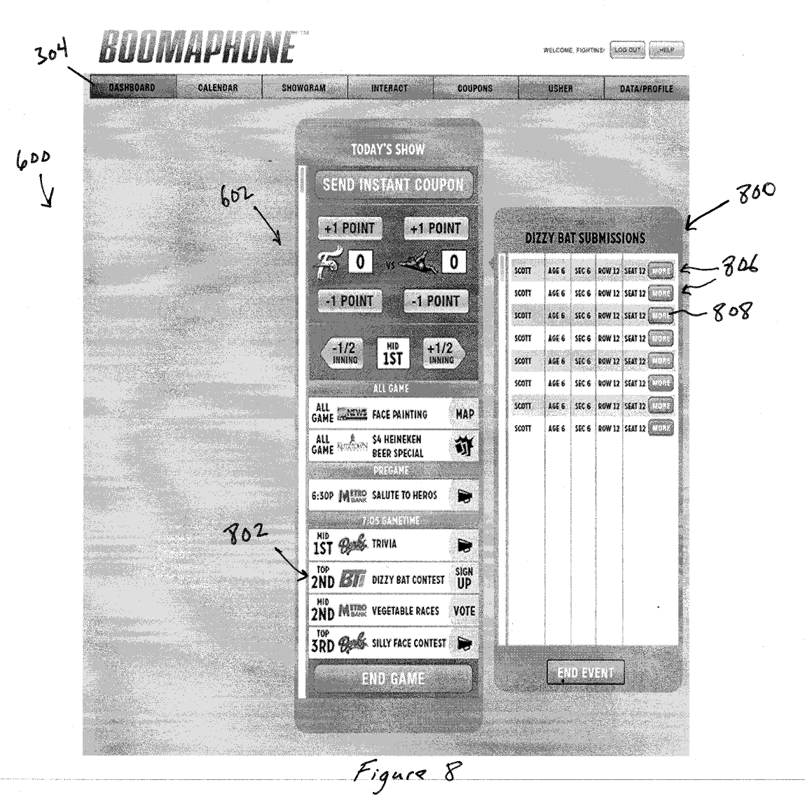

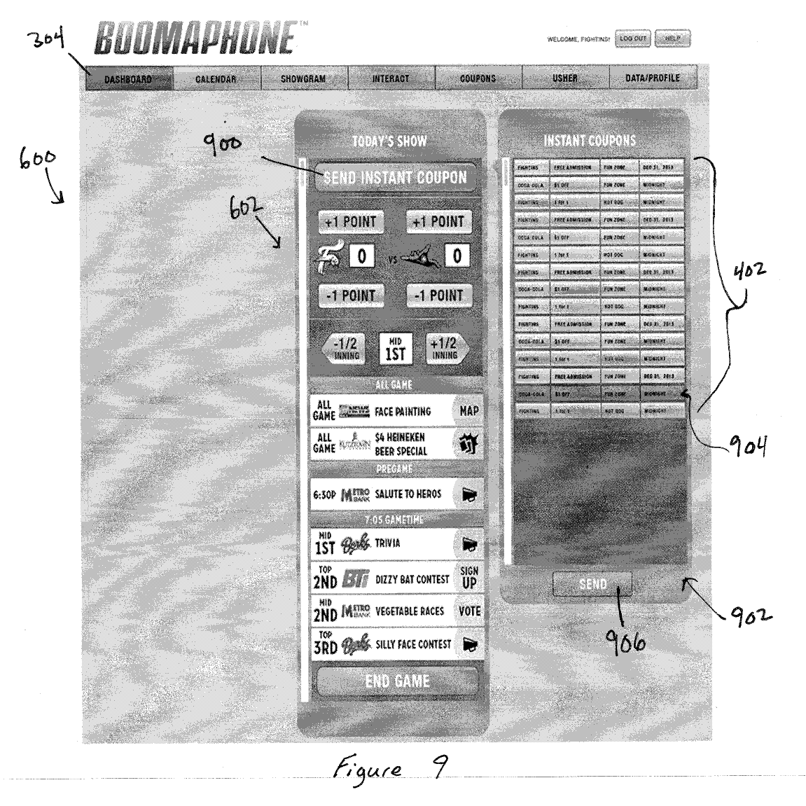

As shown in FIG. 7, the organizer can interact with the control interface 602 to display participation information regarding one or more intra-event activities. For example, the live event manager 126 can populate an area 700 with intra-event activity results 706 and can allow the organizer to end the inter activity event by selecting an “End Event” button 704. In the present embodiment, the intra-event activity can correspond to a contest that users can participate in via the system 150. The users can be presented with a set of options (answers) to choose from and can select one of the options (answers) to cast a vote for the selected option (answer). The organizer, through the area 700 can select which of the answers wins the contest (e.g., based on the answer that received the most votes) by selecting a “Winner” button 702 corresponding to the winning answer.

As shown in FIG. 8, the organizer can interact with the control interface 602 to display participation information regarding one or more intra-event activities. For example, the live event manager 126 can populate an area 800 in response to a selection of a scheduled intra-event activity 802. In the present embodiment, the intra-event activity 802 can correspond to a contest that users can physically participate in after signing up for the contest via the system 150. The participation information displayed in the area 800 can include user sign up information 806 associated with the users, which can include information about the users that have signed up for the intra-event activity, such as names of the participants, ages of the participants, a location of the participants at the venue (e.g., seat location in a stadium), and/or any other suitable participant information. The organizer can view additional participant information by selecting a “More” button 808 that is dispose next to each participant in the sign up list.

As shown in FIG. 9, the control interface 602 can includes a “Send Instant Coupon” button 900 that can be selected by the organizer. Upon selecting the button 900, the live event manager can display an area 902 that includes a list of the coupons in the coupon bank 402. The organizer can select one or more of the coupons from the list (e.g., coupon 904) and can subsequently select a “Send” button 906 to transmit the one or more coupons to the users of the system 150. By allowing the organizer to send instant coupons to the users, the system 110 provides the organizer with the ability to dynamically drive sales traffic during an event for one or more goods or services being offered during the event. Using this approach, the organizer can monitor sales activities during the event and can issue coupons at different times during the event based on the sales activities. As one example, as the end of a baseball game approaches (e.g., around the seventh inning), there may be a surplus of hotdogs remaining to be sold. To help sell the hotdogs, the organizer can send an instant coupon for hotdogs during the seventh inning providing the users of the system 150 with a discount on hotdogs purchased until the end of the baseball game.

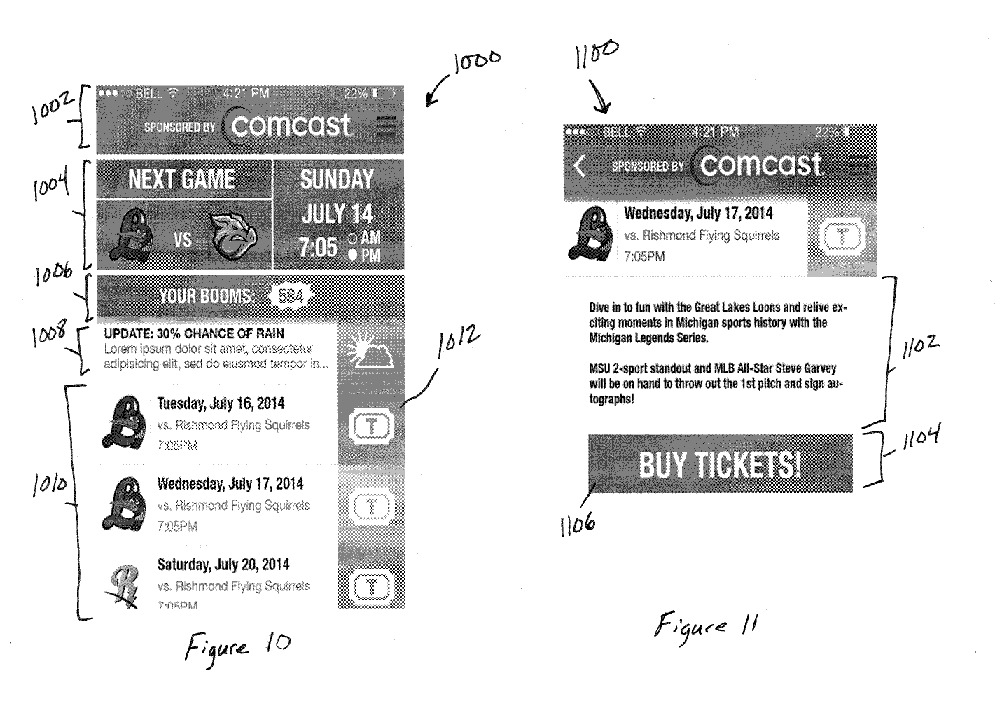

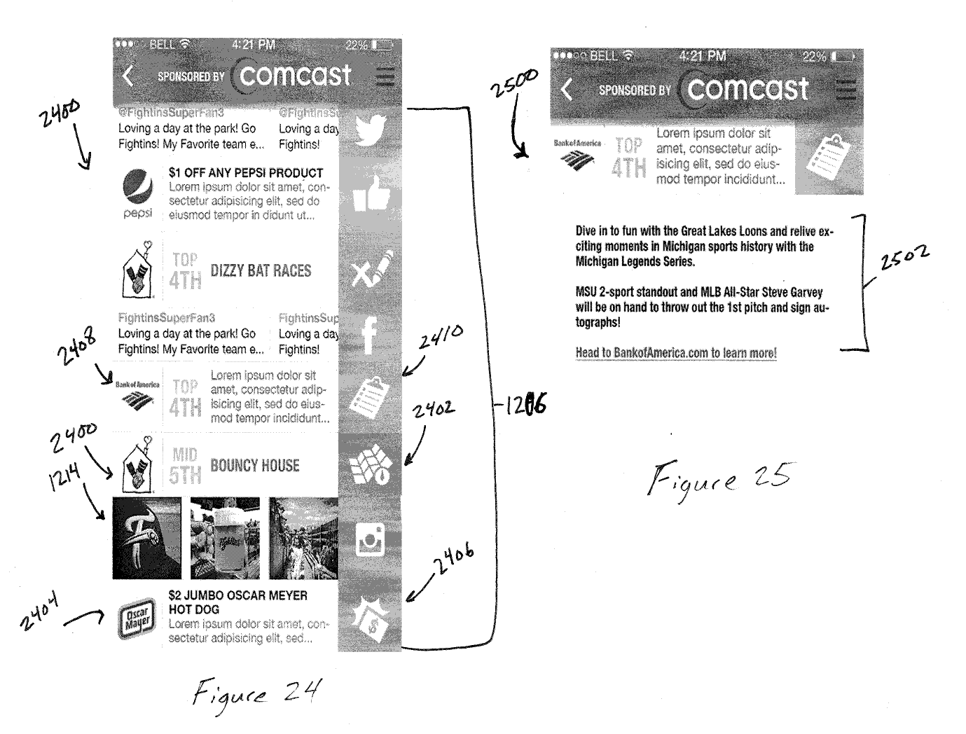

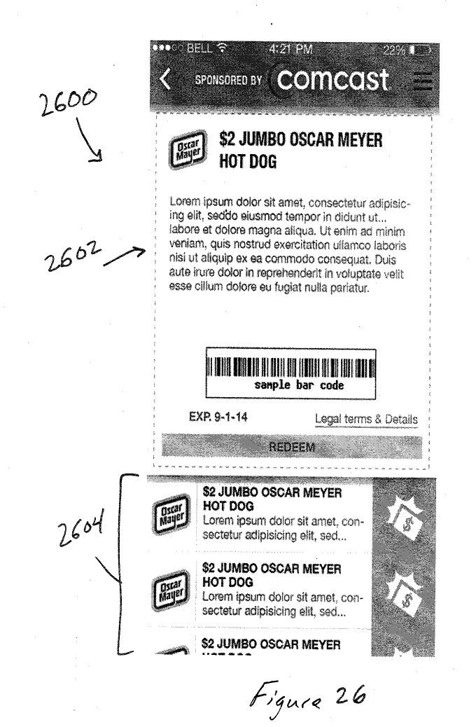

FIGS. 10-37 depict exemplary GUIs (e.g., GUIs 114) that can be rendered on a display of a user device to facilitate interaction with the system 110 by an user in accordance with exemplary embodiments of the present disclosure. The GUIs of FIGS. 10-42 depict an exemplary embodiment in accordance with the present disclosure for implementing the environment with respect to baseball games. While FIG. 10-42 are described with respect to baseball games, those skilled in the art will recognize that exemplary embodiments can be implemented for other sporting events (e.g., basketball football, soccer, hockey, tennis, boxing, etc.) and/or other live events (e.g., conferences, parties, movie screenings, etc.).

FIG. 10 depicts a non-game day GUI 1000 that can be rendered on a user device by an exemplary embodiment of the system 150 based on information received from an exemplary embodiment of the system 110 executed by a server remote to the user device. The GUI 1000 can include a featured sponsor area 1002 that display a featured sponsor of the baseball team for which the system 150 is being implemented, a next game display area 1004 that provides information about the next scheduled baseball game to be played by the baseball team (e.g., the next live event), a points area 1008 that display a quantity of points (“Booms”) accumulated by the user, a weather update area 1010 that provides a weather forecast, and a scheduled baseball games area 1010 that provides a list of scheduled baseball games for the baseball team (e.g., scheduled live events). The areas 1002, 1004, 1006, 1008, and 1010 can be populated with information received from the system 110, which can be specified by the organizer, e.g., upon interaction with the components of the system 110 (e.g., the calendar manager 116, coupon manager 118, activities manager 120, mapping engine 122, feed manager 124, live event manager 126, subscriber manager 128, and/or account manager 130). The area 1010 can include selectable links 1012 that the user can select to navigate to another GUI that provides additional information about the scheduled baseball game corresponding to a selected link. In some embodiments, the links can include can be formed by a row including game information and/or an icon disposed along a right edge of the row.

FIG. 11 depicts a GUI 1100 that can be displayed in response to a selection of one of the selectable links 1012 in the GUI 1000 of FIG. 10. The GUI 1100 can include a description area 1102 and a ticket area 1104. The description area 1102 can include a description corresponding to the scheduled baseball game associated with the selected link, information about a venue for the selected baseball game, intra-event activities scheduled for the event, and the like. The ticket area 1104 can include a link 1106 that can be selected by the user to navigate to a ticket vendor authorized to sell tickets to the scheduled baseball game. In exemplary embodiments, the information included in the description area 1102 and the ticket area 1104 can be specified by the organizer using, for example, an embodiment of the calendar manager 116 of the system 110, which can transmit the information to the user device for display by the user interface 152 of system 150.

FIG. 12 depicts a game day GUI 1200 that can be rendered on a user device by an exemplary embodiment of the system 150 based on information received from an exemplary embodiment of the system 110 executed by a server remote to the user device. The GUI 1200 can include the featured sponsor area 1002, a game update area 1202, the points area 1008, the weather update area 1010, and an intra-game feed area 1206 that provides a data stream corresponding to a data feed specified by the organizer and received by the system 150 from system 110. The areas 1002, 1008, 1202, and 1206 can be populated with information received from the system 110, which can be specified by the organizer, e.g., upon interaction with the components of the system 110 (e.g., the calendar manager 116, coupon manager 118, activities manager 120, mapping engine 122, feed manager 124, live event manager 126, subscriber manager 128, and/or account manager 130).

The game update area 1202 can be a selectable area that includes game data, such as the score, current inning, number of outs, the player at bat, and the like, which can be specified by the organizer via the live event manager 126 of the system 110 and transmitted to the system 150 and/or can be automatically generated and transmitted to the system 110 for display on the user device. Upon selection of the area 1202, the area 1202 can expand to provide more detailed game data 1400 and a social media feed 1402 from the baseball team with game updates 1404, as shown in FIG. 14, which may also include selectable areas that can be selected to display even further game data, such as a full roster of the baseball teams playing the game.

The GUI 1200 also includes a selectable menu area 1226 that can be selected to reveal a set of menu options 1300 on the display of the user device as shown in FIG. 13. Referring to FIG. 13, the menu options can include social media options 1302 for integrating the user's social media accounts (e.g., Facebook, Twitter, Instagram) into the system 150, venue menu options 1304 described in more detail below, customizable menu options 1306 that can be specified by the organizer via the system 110, and a settings menu option 1308 that allows the user to configure the settings for the user's account with the system 150.

Still referring to FIG. 13, the venue menu options 1304 can include a coupons menu option 1310 that allows the user to view available coupons, accumulated coupons, and/or redeemed coupons, a maps option menu 1312 that allows the user to view one or more maps of the venue (e.g., stadium) and interact with visual indicators on the maps, a team stats menu option 1314 that allows the user to view statistic information about the baseball team and the baseball team's players, and a tickets menu option 1316 that allows the user to view ticket information and/or purchase tickets to one or more scheduled baseball games.

Referring now to FIG. 12 and, the data feed included in the feed area 1206 can include game update areas 1204, informational update entries 1208, intra-event activities entries 1210 and 1212, and social media (Instagram) feed area 1214. The entries in the data feed can be arranged in rows and one more of the entries can be positioned within the feed area 1206 based on milestones (e.g., half inning increments) defined for the data feed (e.g., by the organizer via the feed manager 124 of the system 110). For example, the intra-event activity entries 1210 and 1212 can be positioned within the data feed to indicate that the intra-event activity associated with the entry 1210 is scheduled for the top of the third inning, while the intra-event activity associated with the entry 1212 is scheduled for the bottom of the third inning. The game update entries 1208 and the social media feed entries 1214 can be distributed throughout the data feed and may or may be specified to be positioned with respect to one or more of the milestones. The user can expand the feed area 1206 to view more data feed entries as shown in FIG. 15 including a social media (Twitter) feed area 1502 and a coupon entry 1504.

Each entry in the data feed can be selectable and/or can include a selectable icon that can be selected by the user to cause the system 150 to perform one or more actions as described herein. In the present view of the data feed, the data feed includes an information icon 1216 that is associated with one of the informational update entries 1208, a map icon 1218 that is associated with the intra-event activity entry 1210, a game update icon 1220 that is associated with the game update entry 1204, a social media icon 1222 that is associated with the social media feed area 1214, a vote icon 1224 that is associated with the intra-event activity entry 1212, a social media icon 1506 that is associated with the social media feed area 1502, and a social media icon 1508 that is associated with the coupon entry 1504. While non-limiting examples of entries and icons are provided herein, it is contemplated that the data feed can include different, fewer, or more entries and/or icons.

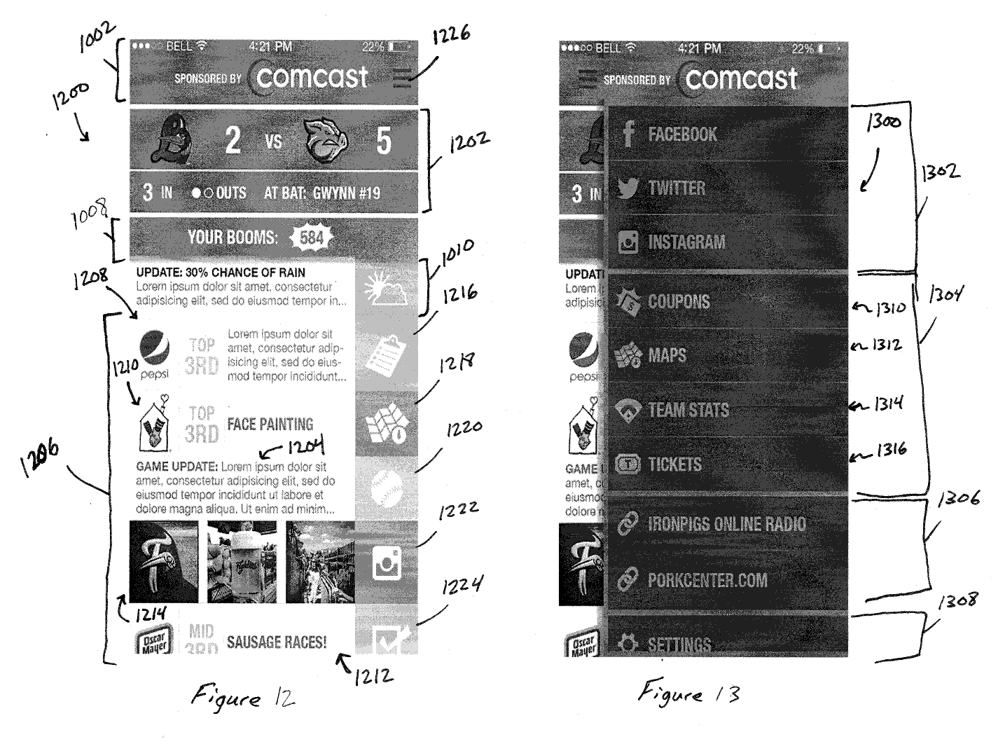

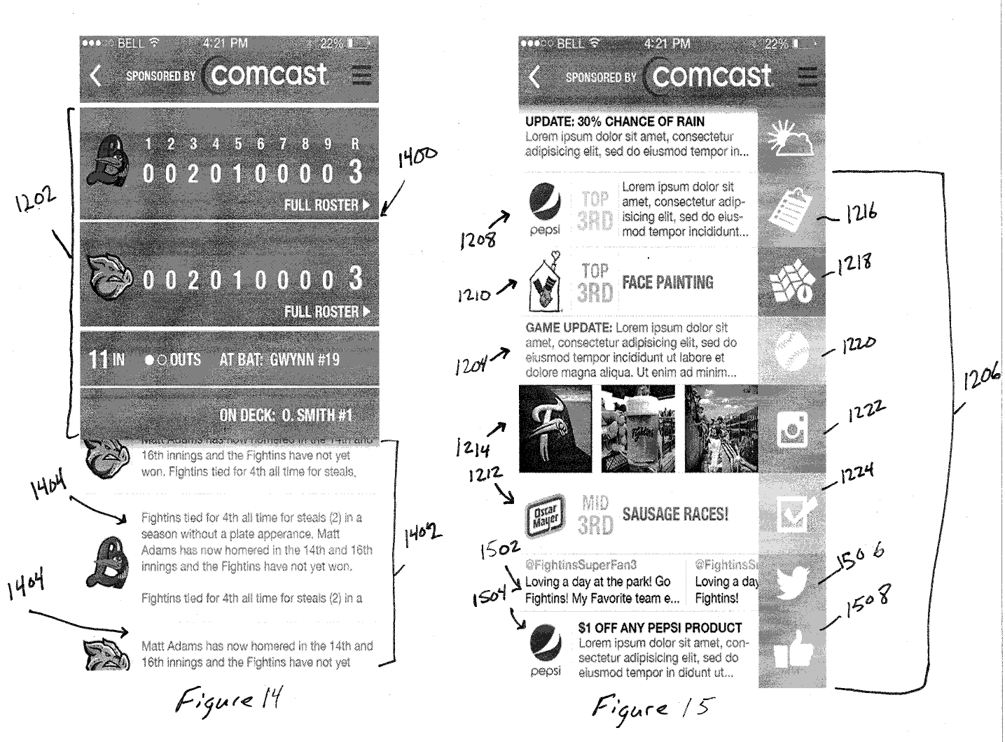

FIGS. 16 and 17 depict GUIs 1600 and 1700, respectively that can be displayed in response to a selection of the intra-event activity entry 1212. In the present embodiment, the intra-event activity entry 1212 can correspond to a virtual contest in which the user is asked to selected the winning option for a chance to win a coupon 1602. With reference to FIG. 16, the GUI 1600 can a set 1604 of options 1606, 1608, and 1610. The user can vote for one of the options in the set 1604 by selecting the option that the user believe will be the winning option. For example, the user can select the option 1606, can return to the GUI 1200 of FIGS. 12 and 15 to await the results of the activity. After the user has voted for an option, the icon 1224 associated with the can change color to provide a visual indication to the user that the user participated in the activity and the user's point total 1800 in the points area 1010 can be incremented as shown in FIG. 18. The user can be alerted by the system 150, e.g., via the data feed if the user selected the winning option. The user can select the alert or the entry 1212 to view the results 1704 of the contest as shown in the GUI 1700 of FIG. 17. A shown in FIG. 17, the user selected the winning option such that the user earned the coupon 1602.

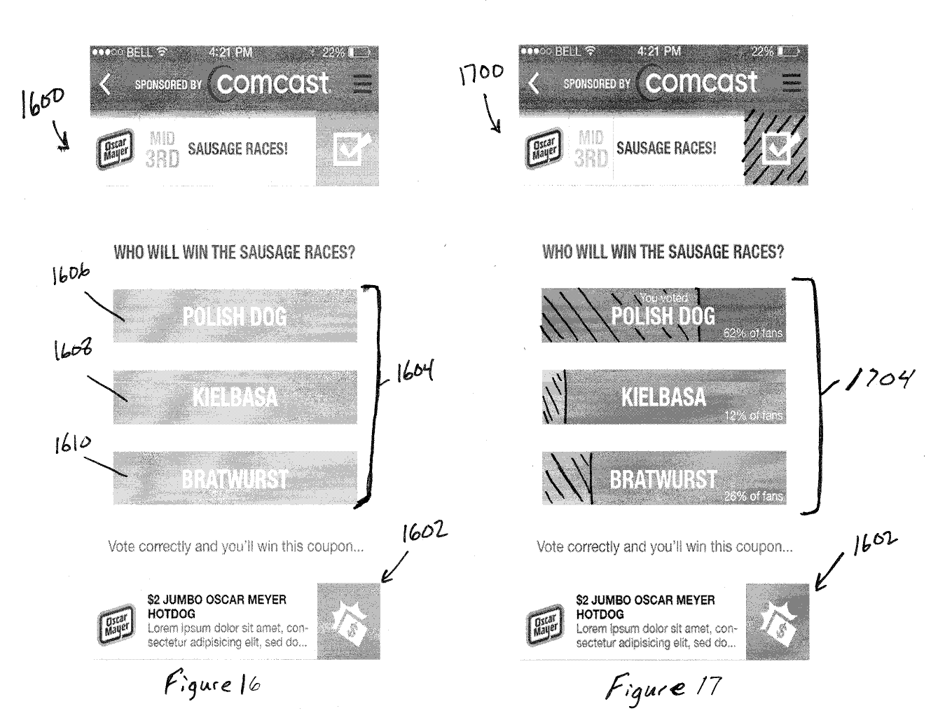

FIG. 19 depicts a GUI 1900 that can be displayed in response to a selection of the points area 1008 (e.g., as shown in FIG. 18). The GUI 1900 can be displayed to the user before the user can access information regarding the user's point total. In the present embodiment, the GUI 1900 can require the user to enter login information, such as a user name via a data entry field 1902.

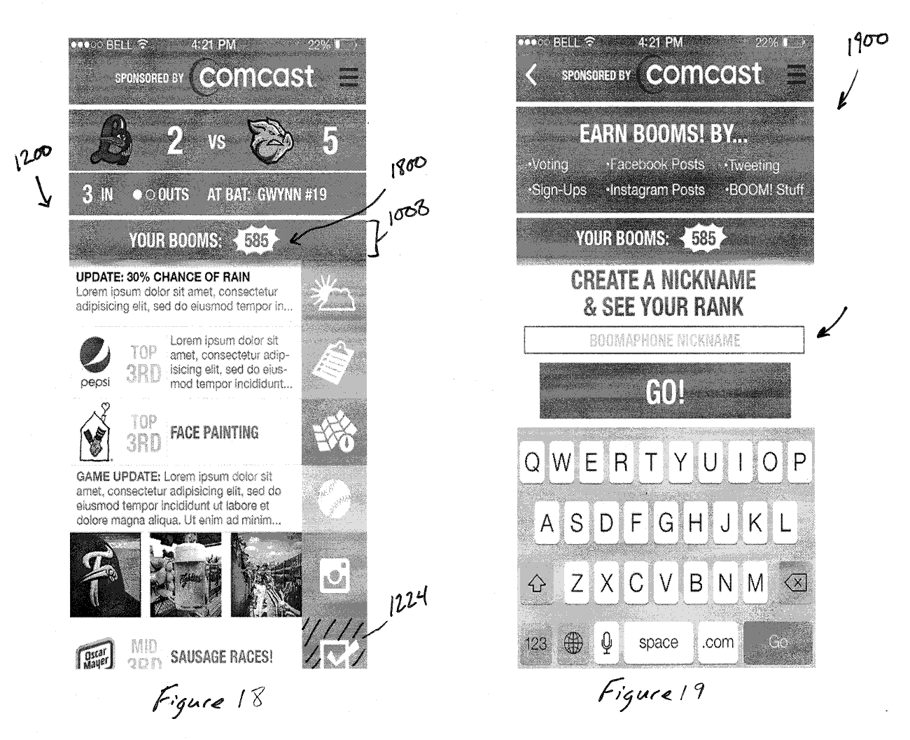

After the user has entered the login information, the user can select a “Go” button 1904 to navigate to a GUI 2000 shown in FIG. 20. The GUI 2000 can provide a list 2002 of users of the environment via an instance of the system 150 and a total quantity of points each user has accumulated. This allows the user to determine the user's point rank compared to other users. In some embodiments, the GUI 200 can also provide information regarding how to redeem services, goods, discounts, and the like using the point that the user has accumulated.

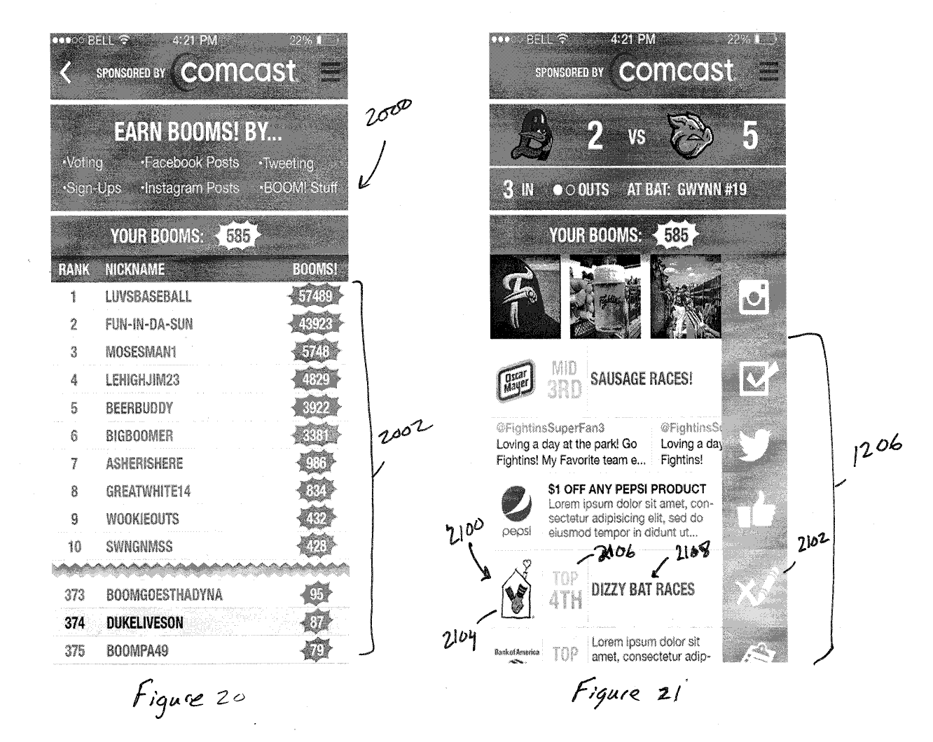

FIG. 21 depicts an update to the feed area 1206 to show feed entries that correspond to new milestones in the baseball game. For example, an intra-event activity entry 2100 having an associated sign-up icon 2102 can be included in the feed area 1206 and can correspond to the milestone of the top of the fourth inning. As baseball game proceeds additional milestones can be reached and additional data feed entries can populate the data feed. At the same time, feed entries from previous milestones can be removed from the feed area 1206 to provide a dynamic feed area 1206 that changes as milestone in the baseball game are reached. In the present embodiment, the intra-event activity is a physical event that users can sign up for. The entry 2100 in the data feed for the activity can show the sponsor 2104 of the event, the milestone 2106 associated with the event, and a title 2108 (or description) of the event. Each of these parameters are specified by the organizer via the organizer's interaction with the system 110 as described herein.

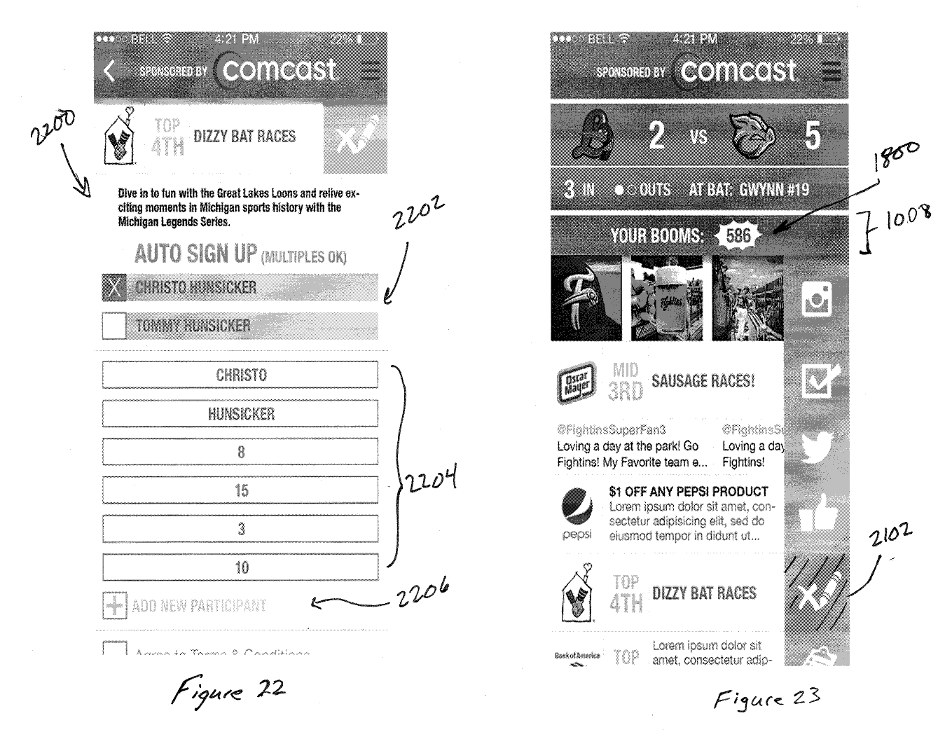

The user can select the entry 2100 and/or the icon 2102 to navigate to a sign-up GUI 2200 shown in FIG. 22. The sign-up GUI 2200 can allow the user sign up for the activity and to sign other individuals up for the activity. The GUI 2200 can include one or more names of individuals 2202 that the user previously entered into the system 150 (e.g., the system 150 can store names of individuals in the user's account for activity sign-ups) to facilitate an auto sign-up operation. For example, the user can select the name of one of the individuals and the system 150 can automatically populate the necessary sign up information 2204 for the selected individual. The GUI 2200 can also allow the user to add a new participant by selecting an “Add New Participant” button 2206. After the user has signed up for an activity, the icon 2102 associated with the activity can change color in the feed area to provide a visual indication to the user that the user has signed up for the activity and the user's point total 1800 in the points area 1010 can be incremented as shown in FIG. 23.

FIG. 24 depicts an update to the feed area 1206 to show feed entries that correspond to new milestones in the baseball game. For example, an intra-event activity entry 2400 having an associated map icon 2402 can be included in the feed area 1206, the social media (Instagram) feed area 1214 can reappear at a different location in the data feed, a coupon enter 2404 having an associated coupon icon 2406 can appear in the data feed, and informational/promotional/advertisement entry 2408 having an informational icon 2410 can be included in the data feed. The appearance of the entries 2400 and 2404 in the feed area 1206 can correspond to the milestone of the middle of the fifth inning being reached.

In some embodiments, the coupon entry 2404 can appear in the feed area 1206 in response to a user's participation in a previous activity. For example, the user can vote for an option in a contest (e.g., as shown in FIGS. 16 and 17), and if the user selects the winning option (as determined, for example, by the organizer), the coupon can be provided to the customer at a later time in the baseball game (e.g., via the coupon entry 2404).

In some embodiments, the feed entries included in the feed area 1206 can include feed entries corresponding to a range of milestones including, for example, milestone that have been previously reached and milestone that are currently occurring as well as milestone that have yet to be reached can be included in the feed area 1206. For example, in a baseball game that is in the bottom of the fifth inning, the feed area can include feed entries corresponding to the feed entries scheduled for two innings in either direction (e.g., from the bottom of the third to the bottom of the seventh).

If the user selects the information/promotional/advertisement entry 2408 and/or informational icon 2410, the GUI 2500 can be displayed to the user to provide the details 2502 of the information/promotional/advertisement. If the user selects the coupon entry 2404 and/or the icon 2406, the GUI 2600 can be displayed to the user display a coupon 2602 corresponding to the entry 2404 and/or to display user's accumulated and/or redeemed coupons 2604 (e.g., upon execution of an embodiment of the coupon manager 162). If the user selects the intra-event activity entry 2400 and/or the map icon 2402, the GUI 2700 shown in FIG. 2700 can display a map 2702 (e.g., upon execution of an embodiment of the mapping engine 166) with a visual indicator 2704 to indicate a location of the intra-event activity to the user and can display information 2706 related to the intra-event activity.

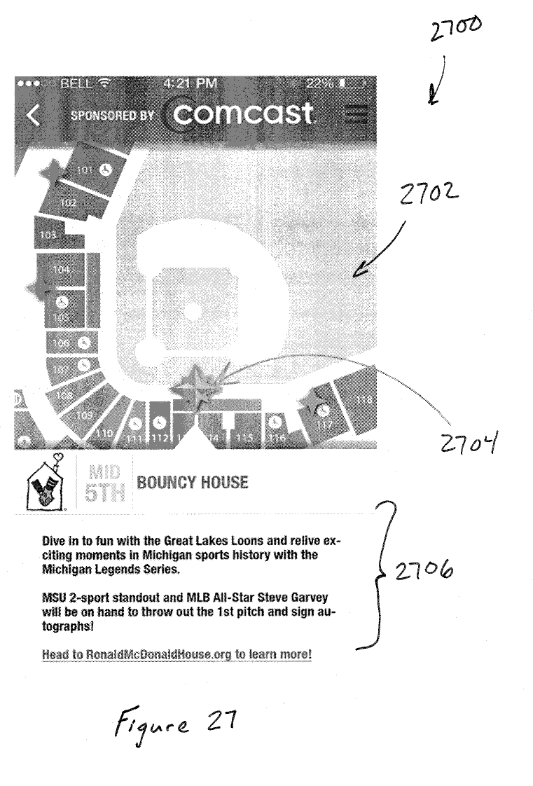

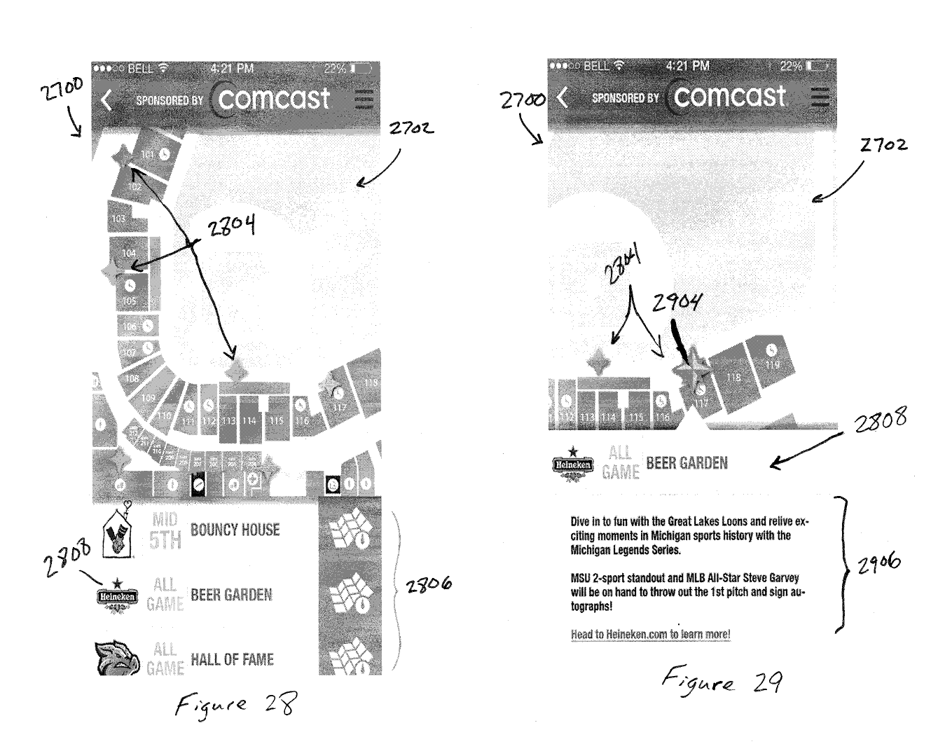

FIGS. 28 and 29 depict exemplary features and/or operations of the GUI 2700 that can be implemented by an exemplary embodiment of the environment 100 in response to, for example, an execution of the mapping engine 122 and/or the mapping engine 162. As shown in FIG. 2800, the map 2702 can include visual indicators 2804 corresponding to locations at which intra-event activities are scheduled to occur, to identify featured vendors, to identify exits and/or restrooms, and any other suitable locations that may be of interest to the user. The user can zoom in, zoom out, and/or pan on the map to view different locations at the venue (e.g., stadium). The GUI 2700 can also include a list 2806 of items including intra-event activities, featured vendors, exits, restrooms, and any other suitable locations that may be of interest to the user. In exemplary embodiments, the GUI 2700 can be programmed and/or configured to allow the user to select the visual indicators 2804 on the map 2702 and/or to select one of the items in the list 2806 to display information specific to the selected visual indicator and/or item in the list 2806 as depict in FIG. 29. For example, with reference to FIG. 29, the user has selected the visual indicator 2904 (or alternatively selected the item 2808 in FIG. 28 corresponding to the indicator 2902) and the GUI 2700 can display the item 2808 and information 2906 related to the location corresponding to the selected visual indicator 2904 or item 2808.

Referring to FIGS. 15 and 30, the user can select the coupon entry 1504 and/or the icon 1508 to retrieve a coupon associated with the entry 1504. In an exemplary embodiment, the coupon can be inactive or locked and selecting the entry 1504 and/or icon 1508 can activate and/or unlock the coupon. The system 150 can alert the user that the coupon has been unlocked via a graphic 3000 that can be rendered on the display of the user device. In the present embodiment, the coupon criteria can be “liking” the coupon on Facebook, which can be achieved by the selection of the entry 1504 and/or icon 1508. By “liking” the coupon, the system 150 can integrate the selection of the entry 1504 and/or icon 1508 into the user's Facebook feed so that the user's “Friends” can see that the user liked the coupon and/or so that the user's “Friends” may acquire the coupon for themselves and/or can be posted on the baseball teams Facebook feed, which can be incorporated into the data feed. In some embodiments, the user can earn a point for selecting the entry 1504 and/or icon 1508.

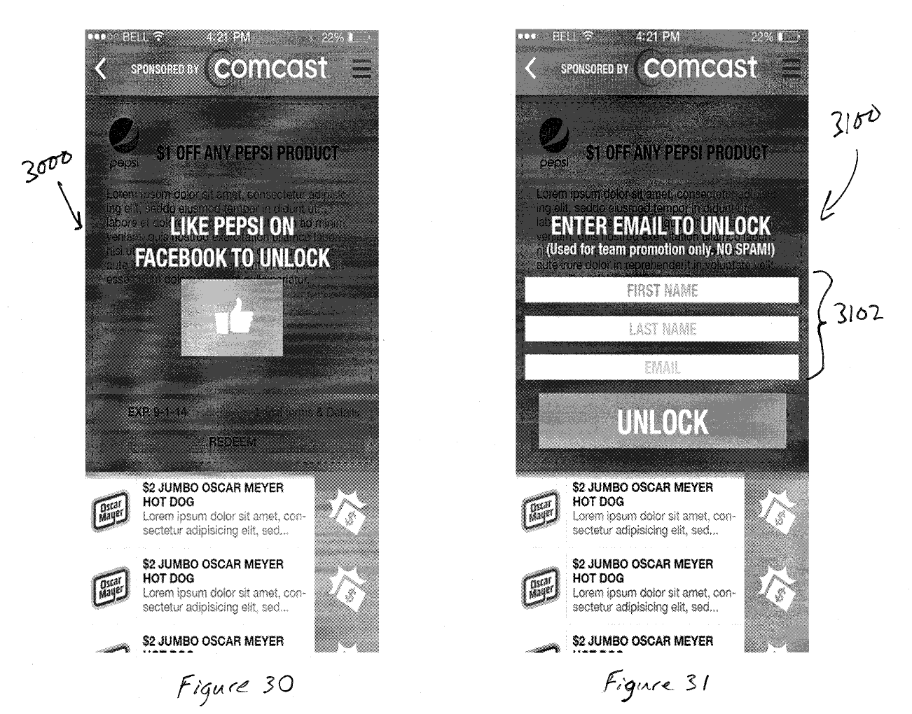

Referring to FIGS. 15 and 31, the user can select the coupon entry 1504 and/or the icon 1508 to retrieve a coupon associated with the entry 1504. In an exemplary embodiment, the coupon can be inactive or locked and a GUI 3100 can be displayed to the user requesting user information 3102 as coupon criteria before the coupon can be activated or unlocked. In the present embodiment, the coupon criteria can request that the user enter a name and e-mail address, which can be subsequently used by the organizer to send promotions to the user.

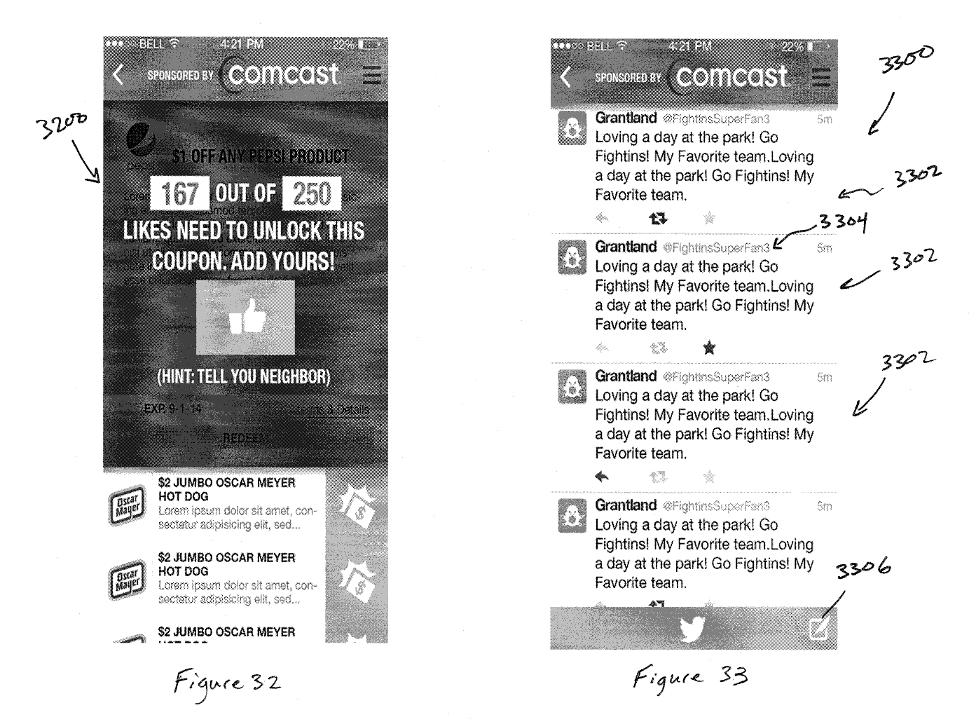

Referring to FIGS. 15 and 32, the user can select the coupon entry 1504 and/or the icon 1508 to retrieve a coupon associated with the entry 1504. In an exemplary embodiment, the coupon can be inactive or locked until a coupon criteria has been satisfied. In the present embodiment, the coupon criteria can require that a specified number of users to select the entry 1504 and/or the icon 1508 before the coupon can be activated or unlocked. In response to the selection by the user a graphic 3200 can be displayed indicating how many users have already participated and how many users are needed before the coupon is activated or unlocked. Selection of the entry 1504 and/or icon 1508 can result in the user “liking” the coupon on Facebook and when the coupon receives the specified number of likes, the system 150 can unlock the coupon.

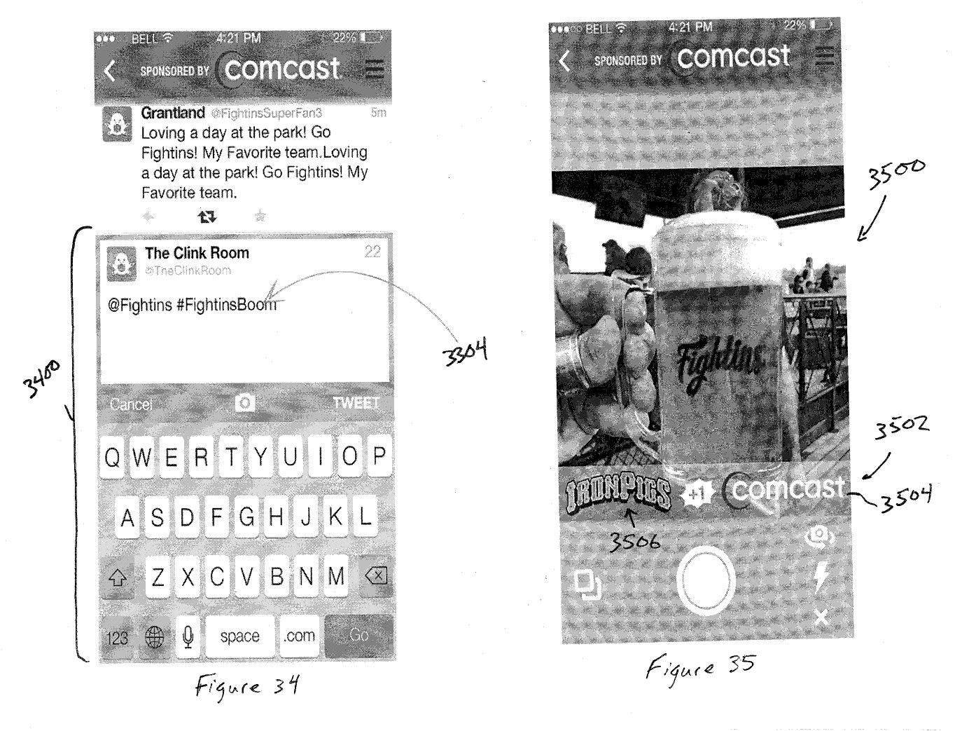

FIG. 33 depicts a GUI 3300 that can be displayed to the user in response to a selection of the entry 1502 and/or icon 1506 of FIG. 15. The GUI 3300 can display twitter posts 3302 having a specified social media hash tag 3304 (e.g., @FightinsSuperFan3), which can be used by the baseball team to communicate to the users and/or can be used by the users to communicate with the baseball team or other users. A user can compose a twitter post be selecting a compose button 3306, which display a data entry area 3400 shown in FIG. 34 that is prepopulated with the hash tag 3304 so that the twitter post entered by the user will include the hash tag 3304 so that is included in the twitter feed incorporated in the data feed. In some embodiments, the user can earn a point for posting a comment to Twitter.

In exemplary embodiments, the user can user an image capture device operatively connected the user device to capture an image 3500 through the system 150 as shown in FIG. 35. In exemplary embodiments, the system 150 can be programmed and/or configured to automatically overlay a watermark 3502 on the image. The watermark 3502 can include sponsor information 3504 and/or baseball team (organization) information 3506. The user can share the image 3500 using one more social media networks (e.g., Facebook, Twitter, Instagram). For example, the user can interface with a GUI 3600 shown in FIG. 3600 to upload the image 3500 to the user's social media account. The user can enter a comment 3602 for the picture and can select one or more social media networks to which the user can post the image 3500 and comment 3602 by selecting one or more of the icons 3604 (e.g., for Instagram), 3606 (e.g., for Facebook), and 3608 (e.g., Twitter). In some embodiments, the user can earn one or more points for posting an image to a social media network.

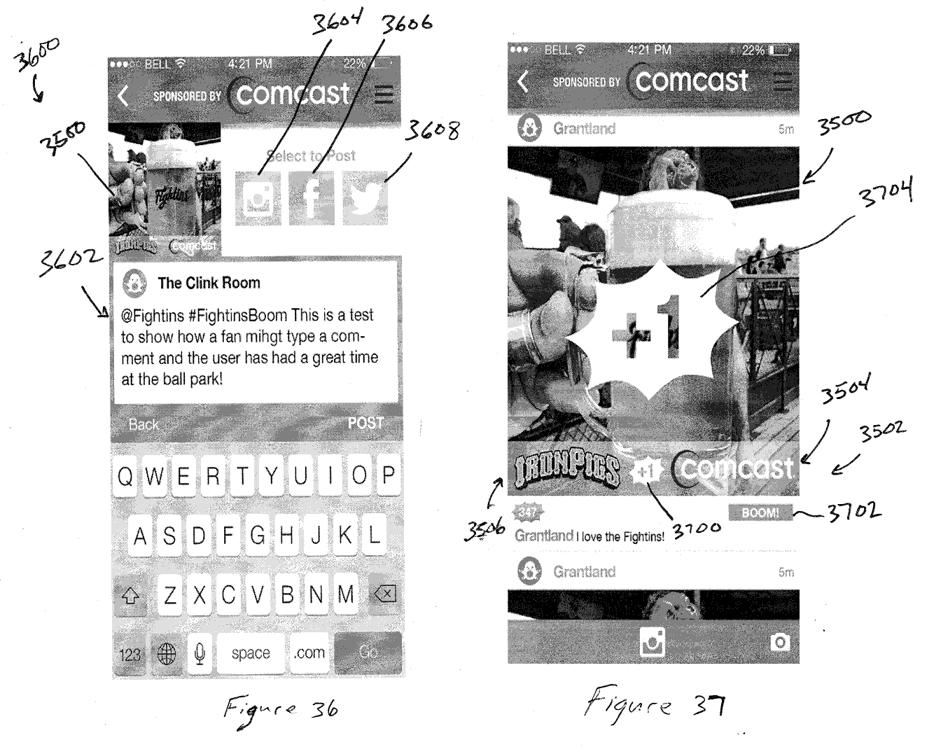

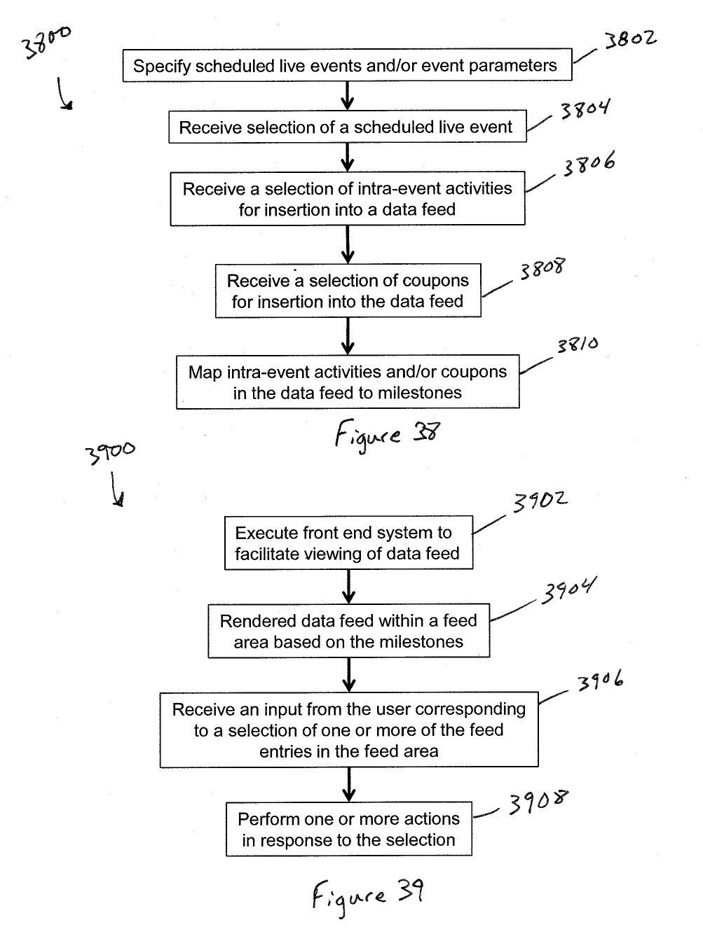

After the image 3500 has been posted, the image 3500 can appear in the social media feed area 1214 within the feed area 1206 (see FIG. 12). User can select the feed area 1214 to view the image 3500 as shown in FIG. 37, which can include a “Boom” button 3702 that can be selected by the user to earn a point as indicated by the graphic 3700 included in the watermark 3502. When the user selects the button 3702, a graphic 3704 can be overlaid on the image 3500 to indicate that the user has earned a point.

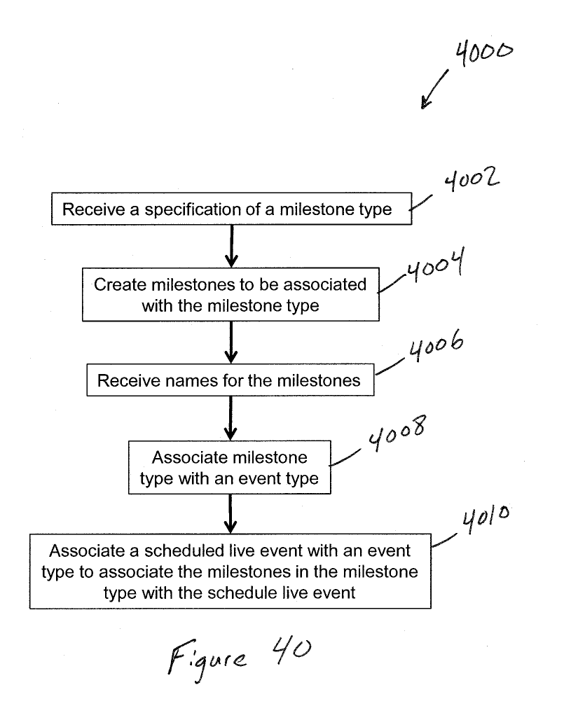

FIG. 38 is a flowchart of an exemplary process 3800 for forming an exemplary data feed to be transmitted from a back end system to a front end system within a live event data feed environment in accordance with exemplary embodiments of the present disclosure. To begin, an exemplary embodiment of the back end system 110 can be executed to allow an organizer to specify one or more scheduled live events and/or one or more parameters for the live events at step 3802. At step 3804, the organizer can select one of the scheduled live events from a graphical user interface provided by the system 110 to begin defining a data feed for the selected scheduled live event. At step 3806, the system 150 can be executed to receive a selection of one or more intra-event activities from an activities bank for insertion into the data feed. As described herein, the intra-event activities can be specified by the organizer via the system 150. At step 3808, the system 150 can be executed to receive a selection of one or more coupons from a coupon bank for insertion into the data feed. As described herein, the coupons can be specified by the organizer via the system 150. At step 3810, the system 150 can be executed to allow the organizer to associate or map one or more of the intra-event activities and/or one or more of the coupons in the data feed to one or more milestones in the data feed to schedule the intra-event activities and coupons throughout the scheduled live event.

FIG. 39 is a flowchart of an exemplary process 3900 for facilitating an interaction with a data feed transmitted in a live event data feed environment in accordance with exemplary embodiments of the present disclosure. To begin, at step 3902, an exemplary embodiment of the front end system 150 can be executed to allow a user to view at least a portion of a data feed received from an embodiment of the system 110. At step 3904, a portion of the data feed can be rendered within a feed area on a display of the user's device based on the milestones defined by the feed such that data/information (e.g., intra-event activities, coupons, social media feeds, map location information) associated or mapped to the milestones in the feed area are visible to the user. In some embodiments, as the live event proceeds, additional milestones can be achieved and additional/new data/information in the feed can be rendered in the feed area. As additional/new data/information is rendered in the feed area, data/information corresponding to at least some of the previously achieved milestones are removed from the feed area so that this data/information is no longer visible to the user. In some embodiments, the user can manually update the feed area throughout the game to update the data/information included in the feed area. At step 3906, the system 150 can receive an input from the user corresponding to a selection of one or more of the feed entries in the feed area and at step 3908, the system 150 can perform one or more actions in response to the selection as described herein.

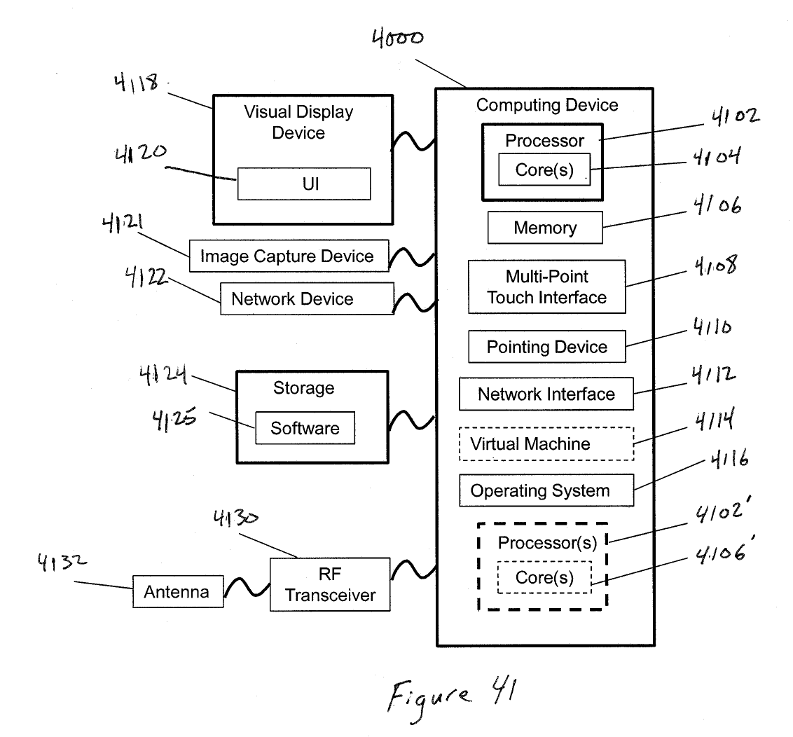

FIG. 40 is a flowchart of an exemplary milestone creation process 4000 that can be implemented in accordance with exemplary embodiments. To begin, at step 4002, an exemplary embodiment of the system 110 can be executed to allow the organizer 102 to specify a milestone type (e.g., Baseball) and at step 4004, the system 150 can be executed to create any number of milestones to be associated with the specified milestone type. At step 4006, each milestone can be given a name (e.g., based on what the milestone represents). At step 4008, the milestones created having a specified milestone type can be associated with or assigned to an event type (e.g., Baseball game) and at step 4010, scheduled live events can be associated with an event type to associate the milestones in the milestone type with the schedule live events to define the milestones for the data feed of the scheduled live events.

FIG. 41 is a block diagram of an exemplary computing device 4100 that may be used to implement exemplary embodiments of the environment 100 described herein. For example, exemplary embodiments of the computing device 1000 can be utilized to implement embodiments of the server(s) 210, the user devices 320-321, and/or the organizer devices 230-231 shown in FIG. 2. While an exemplary embodiment of the computing device is described as including one or more components, those skilled in the art will recognize that exemplary embodiments of the server(s) 210, the user devices 320-321, and/or the organizer devices 230-231 shown in FIG. 2 may or may not include all of the components and/or may include additional or other components. For example, an exemplary embodiment of the server 210 may not include a display device, data entry devices, an image acquisition device, a pointing device, and so on.

The computing device 4100 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 4106 included in the computing device 4100 may store computer-readable and computer-executable instructions or software for implementing exemplary embodiments of the environment 100. The computing device 4100 also includes configurable and/or programmable processor 4102 and associated core 4104, and optionally, one or more additional configurable and/or programmable processor(s) 4102′ and associated core(s) 4104′ (for example, in the case of computer systems having multiple processors/cores), for executing computer-readable and computer-executable instructions or software stored in the memory 4106 and other programs for controlling system hardware. Processor 4102 and processor(s) 4102′ may each be a single core processor or multiple core (4104 and 4104′) processor.

Virtualization may be employed in the computing device 4100 so that infrastructure and resources in the computing device may be shared dynamically. A virtual machine 4114 may be provided to handle a process running on multiple processors so that the process appears to be using only one computing resource rather than multiple computing resources. Multiple virtual machines may also be used with one processor.

Memory 4106 may include a computer system memory or random access memory, such as DRAM, SRAM, EDO RAM, and the like. Memory 4106 may include other types of memory as well, or combinations thereof.

Interaction with the computing device 4100 can be achieved through a visual display device 4118, such as a computer monitor, which may display one or more user interfaces 4120 that may be provided in accordance with exemplary embodiments. The computing device 4100 may include other I/O devices for receiving input from a customer, for example, a keyboard or any suitable multi-point touch interface 4108, a pointing device 4110 (e.g., a mouse). The keyboard 4108 and the pointing device 4110 may be coupled to the visual display device 4118. The computing device 4100 may include other suitable conventional I/O peripherals. For example, in some embodiments, the computing device 4100 can be operatively coupled to an image capture device 4121.

The computing device 4100 may also include one or more storage devices 4124, such as a hard-drive, CD-ROM, Flash memory, or other non-transitory computer readable media, for storing data and computer-readable instructions and/or software 4125 in that implement exemplary embodiments of the environment 100 described herein. As one example, when an embodiment of the computing device 4100 corresponds to the server(s) 210, the one or more storage devices can include an embodiment of the system 110. As one example, when an embodiment of the computing device 4100 corresponds to the user device 220-221, the one or more storage devices can include an embodiment of the system 150. As yet another example, when an embodiment of the computing device 4100 corresponds to the organizer device 320-321, the one or more storage devices can include an embodiment of the client-side application 232.

The computing device 4100 can include a network interface 4112 configured to interface via one or more network devices 4122 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections (including via cellular base stations), controller area network (CAN), or some combination of any or all of the above. In exemplary embodiments, the computing device 4100 can include a radio frequency transceiver 4130 operatively coupled to one or more antennas 4132 to facilitate wireless communication (e.g., via the network interface) between the computing device 4100 and a network. The network interface 4112 may include a built-in network adapter, network interface card, PCMCIA network card, card bus network adapter, wireless network adapter, USB network adapter, modem or any other device suitable for interfacing the computing device 4100 to any type of network capable of communication and performing the operations described herein. Moreover, the computing device 4100 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 4100 may run any operating system 4116, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 4116 may be run in native mode or emulated mode. In an exemplary embodiment, the operating system 4116 may be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A computer-implemented method of forming a data feed associated with a live event for transmission to attendees of the live event, the method comprising:
executing code to construct a data feed including an intra-event activity for a live event;
scheduling the intra-event activity in the data feed according to a milestone associated with the live event via a user interface;
associating one or more activity parameters with the intra-event activity; and
electronically transmitting the data feed to a computing device associated with an attendee of the live event for rendering of the data feed on a display of the computing device.

2. The method of claim 1, wherein the at least a portion of the data feed is electronically transmitted to the computing device based on the milestone.

3. The method of claim 1, further comprising:
receiving a selection of the intra-event activity from an activity bank retrieved from a non-transitory computer-readable storage medium; and
inserting the intra-event activity into the data feed in response to the selection.

4. The method of claim 1, wherein associating one or more activity parameters with the intra-event activity comprises:
receiving an input from an organizer specifying sponsor information for the intra-event activity via the user interface; and
storing the sponsor information from the organizer for a sponsor parameter of the intra-event activity,
wherein the sponsor information is included in the data feed and being transmitted in the data feed to the computing device associated with an attendee for rendering of the sponsor information on the display of the computing device with the intra-event activity.

5. The method of claim 1, further comprising:
associating the intra-event activity with a location on a geographic map of a venue for the live event; and
overlaying a visual indicator on the geographic map of the venue to identify the location of the intra-event activity.

6. The method of claim 1, further comprising:
receiving a selection of a coupon from a coupon bank retrieved from a non-transitory computer-readable storage medium; and
inserting the coupon into the data feed in response to the selection.

7. The method of claim 6, further comprising:
implementing a coupon criteria to be satisfied before the coupon becomes active; and
activating the coupon in response to satisfaction of the coupon criteria.

8. The method of claim 7, wherein satisfaction of the coupon criteria comprises participation by the attendee in the intra-event activity.

9. The method of claim 7, wherein satisfaction of the coupon criteria comprises performance of an action by the attendee in the data feed.

10. The method of claim 1, further comprising incorporating a social media feed into the data feed.

11. The method of claim 1, wherein the live event is a baseball game and the milestone is based on innings of the baseball game.

12. A system for forming a data feed associated with a live event for transmission to attendees of the live event, the system comprising:
one or more non-transitory computer-readable media storing executable instructions for forming a data feed for a live event; and
one or more processing devices programmed to execute the instructions to:
construct a data feed including an intra-event activity for a live event;
schedule the intra-event activity in the data feed according to a milestone associated with the live event via a user interface;
associate one or more activity parameters with the intra-event activity; and
initiate transmission of the data feed to a computing device associated with an attendee of the live event for rendering of the data feed on a display of the computing device.

13. The system of claim 12, wherein the one or more processing devices are programmed to:
receive a selection of the intra-event activity from an activity bank retrieved from the one or more non-transitory computer-readable storage media; and
insert the intra-event activity into the data feed in response to the selection.

13. The system of claim 12, wherein the one or more processing devices are programmed to associate one or more activity parameters with the intra-event activity in response to receiving an input from an organizer specifying sponsor information for the intra-event activity via the user interface, the one or more processing devices executing the instructions to store the sponsor information from the organizer for a sponsor parameter of the intra-event activity,
wherein the sponsor information is included in the data feed and being transmitted in the data feed to the computing device associated with an attendee for rendering of the sponsor information on the display of the computing device with the intra-event activity.

14. The system of claim 12, wherein the one or more processing devices are programmed to
associate the intra-event activity with a location on a geographic map of a venue for the live event; and
overlay a visual indicator on the geographic map of the venue to identify the location of the intra-event activity.

15. The system of claim 12, wherein the one or more processing devices are programmed to receive a selection of a coupon from a coupon bank retrieved from the one or more non-transitory computer-readable storage media, the one or more processing devices executing the instructions to insert the coupon into the data feed in response to the selection.

16. The system of claim 15, wherein the one or more processing devices are programmed to implement a coupon criteria to be satisfied before the coupon becomes active and activate the coupon in response to satisfaction of the coupon criteria.

17. One or more non-transitory computer-readable storage media storing executable instructions, wherein execution of the instructions by one or more processing device causes the one or more processing device to implement a process of forming a data feed associated with a live event for transmission to attendees of the live event comprising:
constructing a data feed including an intra-event activity for a live event;
scheduling the intra-event activity in the data feed according to a milestone associated with the live event via a user interface;
associating one or more activity parameters with the intra-event activity; and
electronically transmitting the data feed to a computing device associated with an attendee of the live event for rendering of the data feed on a display of the computing device.

18. The one or more non-transitory computer-readable storage media of claim 17, wherein execution of the instructions by the one or more processing devices causes the processing device to receive a selection of the intra-event activity from an activity bank retrieved from the one or more non-transitory computer-readable storage media and insert the intra-event activity into the data feed in response to the selection.

19. The one or more non-transitory computer-readable storage media of claim 17, wherein execution of the instructions by the one or more processing devices causes the processing device to associate one or more activity parameters with the intra-event activity in response to receiving an input from an organizer specifying sponsor information for the intra-event activity via the user interface, the one or more processing devices executing the instructions to store the sponsor information from the organizer for a sponsor parameter of the intra-event activity,
wherein the sponsor information is included in the data feed and being transmitted in the data feed to the computing device associated with an attendee for rendering of the sponsor information on the display of the computing device with the intra-event activity.

20. A method of interacting with an attendee of a live event based on data feed associated with the live, the method comprising:
receiving a data feed via a computing device, the data feed including an intra-event activity for a live event, the intra-event activity in the data feed being scheduled during the live event according to a milestone of the live event; and
rendering the intra-event activity in the data feed on a display of the computing device in response to milestone.

21. The method of claim 20, further comprising:
receiving an image captured by an image acquisition device operatively coupled to the computing device;
overlaying on the image a watermark including sponsor information;
providing an interface with a prepopulated hash tag to allow the user to post the image on a social media network with the hash tag; and
incorporating the image with the watermark into the data feed.

22. The method of claim 20, further comprising updating the data feed in response to achievement of a milestone.

23. The method of claim 22, wherein the achievement of a milestone is determined based on event information.
